(19) United States
(12) Patent Application Publication
(10) Pub. No.: US 2026/0323192 A1
(43) Pub. Date: Oct. 15, 2026

(54) SYSTEM INCLUDING A PASSIVE OPTICAL NETWORK

(71) Applicant: ARRIS Enterprises LLC, Horsham, PA (US)

(72) Inventors: David BOWLER, Stow, MA (US); Michael J. EMMENDORFER, Saint Peters, MO (US); Khalid W. AL-MUFTI, Sterling, VA (US); Bruce C. PRATT, Bedford, NH (US); John Charles CHAMBERLAIN, Hickory, NC (US); Erik J. GRONVALL, Bloomington, MN (US)

(73) Assignee: ARRIS Enterprises LLC, Horsham, PA (US)

(21) Appl. No.: 19/107,478

(22) PCT Filed: Aug. 25, 2023
(86) PCT No.: PCT/US2023/031198

§ 371 Date: Feb. 27, 2025

Related U.S. Application Data
(60) Provisional application No. 63/404,285, filed on Sep. 7, 2022.
(60) Provisional application No. 63/409,514, filed on Sep. 23, 2022.
(60) Provisional application No. 63/430,315, filed on Dec. 5, 2022.
(60) Provisional application No. 63/431,578, filed on Dec. 9, 2022.
(60) Provisional application No. 63/431,588, filed on Dec. 9, 2022.
(60) Provisional application No. 63/431,597, filed on Dec. 9, 2022.
(60) Provisional application No. 63/431,933, filed on Dec. 12, 2022.
(60) Provisional application No. 63/432,674, filed on Dec. 14, 2022.
(60) Provisional application No. 63/432,971, filed on Dec. 15, 2022.
(60) Provisional application No. 63/435,504, filed on Dec. 27, 2022.
(60) Provisional application No. 63/435,524, filed on Dec. 27, 2022.

(51) Int. Cl. H04Q 11/00

(52) U.S. Cl. CPC H04Q 11/0067; H04Q 2011/0064; H04Q 2011/0086

(57) ABSTRACT

A system for passive optical networks.

### CROSS REFERENCE TO RELATED APPLICATIONS

This application claims the benefit of U.S. Provisional Patent Application Ser. No. 63/435,504 filed Dec. 27, 2022 entitled MULTI-LEVEL MESSAGE PRIORITIZATION FOR PASSIVE OPTICAL NETWORK;
claims the benefit of U.S. Provisional Patent Application Ser. No. 63/430,315 filed Dec. 5, 2022 entitled LOW LATENCY PASSIVE OPTICAL NETWORK;
claims the benefit of U.S. Provisional Patent Application Ser. No. 63/431,933 filed Dec. 12, 2022 entitled PASSIVE OPTICAL NETWORK OVERSUBSCRIPTION FOR CELLULAR X-HAUL;
claims the benefit of U.S. Provisional Patent Application Ser. No. 63/435,524 filed Dec. 27, 2022 entitled PASSIVE OPTICAL NETWORK SUPPORTING CPRI AND ECPRI;
claims the benefit of U.S. Provisional Patent Application Ser. No. 63/431,578 filed Dec. 9, 2022 entitled MIXED CELLULAR PASSIVE OPTICAL NETWORK;
claims the benefit of U.S. Provisional Patent Application Ser. No. 63/431,597 filed Dec. 9, 2022 entitled TIMING AND SCHEDULING FOR PASSIVE OPTICAL NETWORK;
claims the benefit of U.S. Provisional Patent Application Ser. No. 63/431,588 filed Dec. 9, 2022 entitled TIMING AND SYNCHRONIZATION FOR PASSIVE OPTICAL NETWORK;
claims the benefit of U.S. Provisional Patent Application Ser. No. 63/432,674 filed Dec. 14, 2022 entitled INTEGRATED PASSIVE OPTICAL NETWORK FOR CELLULAR FOR X-HAUL;
claims the benefit of U.S. Provisional Patent Application Ser. No. 63/432,971 filed Dec. 15, 2022 entitled INTEGRATED PASSIVE OPTICAL NETWORK WITH X-HAUL AND ETHERNET;
claims the benefit of U.S. Provisional Patent Application Ser. No. 63/404,285 filed Sep. 7, 2022 Entitled BANDWIDTH ALLOCATION BASED UPON PROSPECTIVE DATA DEMAND;
claims the benefit of U.S. Provisional Patent Application Ser. No. 63/409,514 filed Sep. 23, 2022 entitled A PON ENABLED SYSTEM WITH A BASEBAND UNIT AND A REMOTE UNIT OF A RADIO ACCESS NETWORK.

### BACKGROUND

The subject matter of this application relates to passive optical networks.

A passive optical network (PON) is often employed as an access network, or a portion of a larger communication network. The communication network typically has a high-capacity core portion where data or other information associated with telephone calls, digital television, and Internet communications is carried substantial distances. The core portion may have the capability to interact with other networks to complete the transmission of telephone calls, digital television, and Internet communications. In this manner, the core portion in combination with the passive optical network enables communications to and communications from subscribers (or otherwise devices associated with a subscriber, customer, business, or otherwise).

The access network of the communication network extends from the core portion of the network to individual subscribers, such as those associated with a particular residence location (e.g., business location). The access network may be wireless access, such as a cellular network, or a fixed access, such as a passive optical network or a cable network.

Referring to FIG. 1, in a PON 10, a set of optical fibres and passive interconnecting devices are used for most or all of the communications through the extent of the access network. A set of one or more optical network terminals (ONTs) 11 are devices that are typically positioned at a subscriber's residence location (e.g., or business location). The term “ONT” includes what is also referred to as an optical network unit (ONU). There may be any number of ONTs associated with a single optical splitter 12. By way of example, 32 or 64 ONTs are often associated with the single network optical splitter 12. The optical splitter 12 is interconnected with the respective ONTs 11 by a respective optical fiber 13, or otherwise a respective fiber within an optical fiber cable. Selected ONTs may be removed and/or added to the access network associated with the optical splitter 12, as desired. There may be multiple optical splitters 12 that are arranged in a cascaded arrangement.

The optical fibers 13 interconnecting the optical splitter 12 and the ONTs 11 act as access (or “drop”) fibers. The optical splitter 12 is typically located in a street cabinet or other structure where one or more optical splitters 12 are located, each of which are serving their respective set of ONTs. In some cases, an ONT may service a plurality of subscribers, such as those within a multiple dwelling unit (e.g., apartment building). In this manner, the PON may be considered a point to multipoint topology in which a single optical fiber serves multiple endpoints by using passive fiber optic splitters to divide the fiber bandwidth among the endpoints.

An optical line terminal (OLT) 14 is located at the central office where it interfaces directly or indirectly with a core network 15. An interface 16 between the OLT 14 and the core network 15 may be one or more optical fibers, or any other type of communication medium. The OLT 14 forms optical signals for transmission downstream to the ONTs 11 through a feeder optical fiber 17, and receives optical signals from the ONTs 11 through the feeder optical fiber 17. The optical splitter 12 is typically a passive device that distributes the signal received from the OLT 14 to the ONTs 11. Similarly, the optical splitter 12 receives optical signals from the ONTs 11 and provides the optical signals though the feeder optical fiber 17 to the OLT 14. In this manner, the PON includes an OLT with a plurality of ONTs, which reduces the amount of fiber necessary as compared with a point-to-point architecture.

As it may be observed, an optical signal is provided to the feeder fiber 17 that includes all of the data for the ONTs 11. Accordingly, all the data being provided to each of the ONTs is provided to all the ONTs through the optical splitter 12. Each of the ONTs selects the portions of the received optical signals that are intended for that particular ONT and passes the data along to the subscriber, while discarding the remaining data. Typically, the data to the ONTs are time divisional multiplexed to the feeder fiber 17, and similarly time division multiplexed to each of the ONTs.

Upstream transmissions from the ONTs 11 through the respective optical fibers 13 are typically transmitted in bursts according to a schedule provided to each ONT by the OLT. In this way, each of the ONTs 11 will transmit upstream optical data at different times. In some embodiments, the upstream and downstream transmissions are transmitted using different wavelengths of light so that they do not interfere with one another. In this manner, the PON may take advant-age of wavelength-division multiplexing, using one wavelength for downstream traffic and another wavelength for upstream traffic on a single mode fiber.

The schedule from the OLT allocates upstream bandwidth to the ONTs. Since the optical distribution network is shared, the ONT upstream transmission would likely collide if they were transmitted at random times. The ONTs typically lie at varying distances from the OLT and/or the optical splitter, resulting in a different transmission delay from each ONT. The OLT measures the delay and sets a register in each ONT to equalize its delay with respect to the other ONTs associated with the OLT. Once the delays have been accounted for, the OLT transmits so-called grants in the form of grant maps to the individual ONTs. A grant map is a permission to use a defined interval of time for upstream transmission. The grant map is dynamically recalculated periodically, such as for each frame. The grant map allocates bandwidth to all the ONTs, such that each ONT receives timely bandwidth allocation for its service needs. Much of the data traffic, such as browsing websites, tends to have bursts and tends to be highly variable over time. By way of a dynamic bandwidth allocation (DBA) among the different ONTs, a PON can be oversubscribed for upstream traffic.

### BRIEF DESCRIPTION OF THE DRAWINGS

For a better understanding of the invention, and to show how the same may be carried into effect, reference will now be made, by way of example, to the accompanying drawings, in which:

FIG. 1 illustrates a network that includes a passive optical network.

FIG. 2 illustrates a passive optical network with downstream data traffic.

FIG. 3 illustrates a passive optical network with upstream data traffic.

FIG. 4 illustrates a remote OLT.

FIG. 5 illustrates an exemplary OLT.

FIG. 6 illustrates a vOLT and OLT.

FIG. 7 illustrates a 4G network.

FIG. 8 illustrates a 5G network.

FIG. 9 illustrates a radio based network.

FIG. 10 illustrates frames with data therein.

FIG. 11 illustrates upstream and downstream frames.

FIG. 12 illustrates a frame with pre-allocated portions.

FIG. 13 illustrates the use of time sensitive message with pre-allocated portions of a frame.

FIG. 14 illustrates prioritization for x-haul service.

FIG. 15 illustrates a combination of a 4G and 5G network.

FIG. 16 illustrates a combination of a 4G and 5G network together with PON.

FIG. 17 illustrates an ONT receiving and transmitting CPRI and eCPRI data.

FIG. 18 illustrates the ONT processing CPRI data.

FIG. 19 illustrates a combination of a 4G and 5G network.

FIG. 20 illustrates a combination of a 4G and 5G network together with PON.

FIG. 21 illustrates modification of the PON transmission for a 4G and 5G network.

FIG. 22 illustrates synchronized radio transmissions for 4G and 5G.

FIG. 23 illustrates a set of distributed radio units interconnected to a PON based fronthaul interconnection.

FIG. 24 illustrates two sets of distributed radio units interconnected to a PON based fronthaul interconnection.

FIG. 25 illustrates framing for cellular networks.

FIG. 26 illustrates an offset in the framing of PON and cellular networks.

FIG. 27 illustrates adjusting the offsetting in the framing of PON and cellular networks.

FIG. 28 illustrates a network architecture.

FIG. 29 illustrates another network architecture.

FIG. 30 illustrates another network architecture.

FIG. 31 illustrates a tower with 4G cellular communications.

FIG. 32 illustrates a mixed 4G and 5G network with a passive optical network.

FIG. 33 illustrates a network with antennas, radio units, ONTs, splitters/taps, and a remote-OLT/OLT.

FIG. 34 illustrates a network with a mixture of Ethernet and PON.

FIG. 35 illustrates an ONT with Ethernet and PON interconnections.

FIG. 36 illustrates a baseband unit and remote radio units.

FIG. 37 illustrates a baseband unit, remote radio units, an ONT, an OLT, and a core network.

FIG. 38 illustrates optical line terminal pre-allocation of bandwidth.

FIG. 39 illustrates optical line terminal monitored data communications.

FIG. 40 is a block diagram of a distributed radio access network (RAN).

FIG. 41 is a block diagram of an embodiment of a distributed RAN.

FIG. 42 is a block diagram of an embodiment an RRU.

FIG. 43 is a block diagram of an embodiment of a BBU.

FIG. 44 is a block diagram of an embodiment of a distributed RAN using a synchronization device.

FIG. 45 illustrates an exemplary baseband unit and remote radio units interconnected by an Ethernet switch.

FIG. 46 illustrates an exemplary baseband unit and remote radio units interconnected by a PON based access network.

FIG. 47 illustrates timing signalling for a PON based access network.

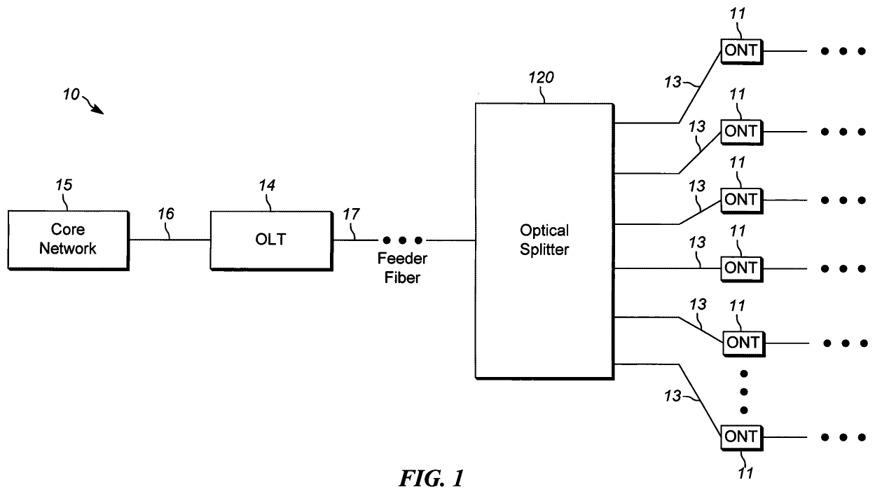

### DETAILED DESCRIPTION

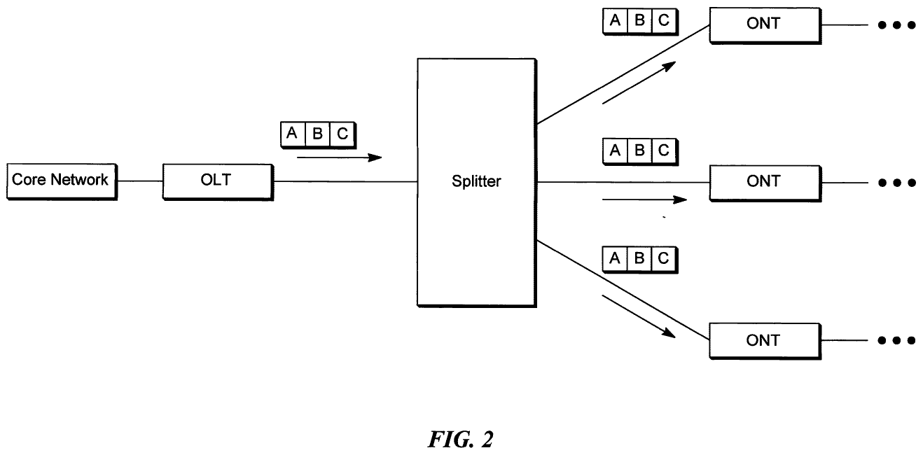

Referring to FIG. 2, the PON network is based upon a point to multi-point downstream transmission arrangement. The data from the OLT is transmitted to all of the ONTs that are interconnected thereto. The data from the OLT is transmitted in the form of one or more frames, where each frame includes data for one or more of the ONTs. For example, in GPON a constant of 125 μs frame is used, where each frame includes (among other control information) an allocation map which informs on the slots granted to allocation ids. Accordingly, each frame is broken up into one or more timeslots that are designated for a corresponding selected one of the ONTs.

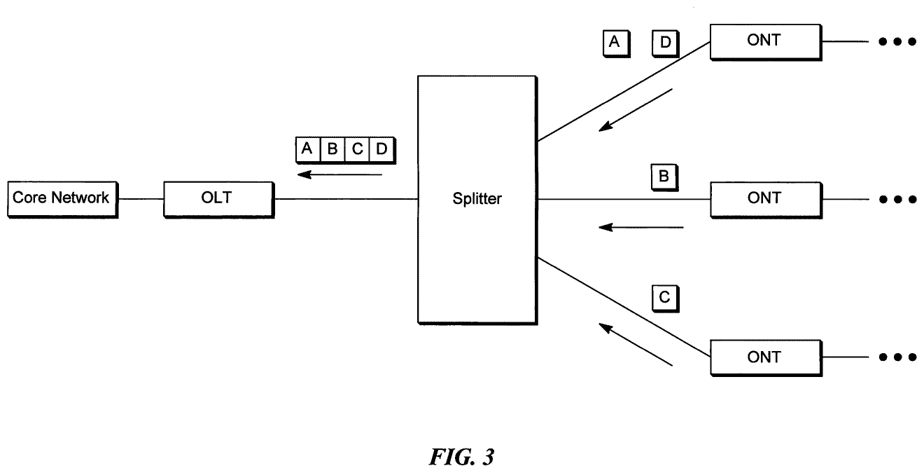

Referring to FIG. 3, the PON network is based upon a multi-point to point upstream transmission arrangement using a time divisional multiple access mechanism. The OLT assigns timeslots (BWmaps) for each ONT to transmit its upstream transmission to ensure a collision free transmission. The data from each of the ONTs is transmitted to the corresponding OLT that it is interconnected thereto. The data from the ONT is transmitted in the form of a portion of one or more frames, where each frame includes data for one or more of the ONTs. For example, in GPON a reference frame of 125 μs frame is used, which is not an absolute value since a round of allocations may span through multiple upstream frames. GPON uses a Generic Encapsulation Method (GEM), which allows for the transport, segmentation and reassembly of Ethernet frames and legacy traffic (ATM or TDM). Accordingly, each frame is broken up into one or more timeslots that are designated for a corresponding selected one of the ONTs.

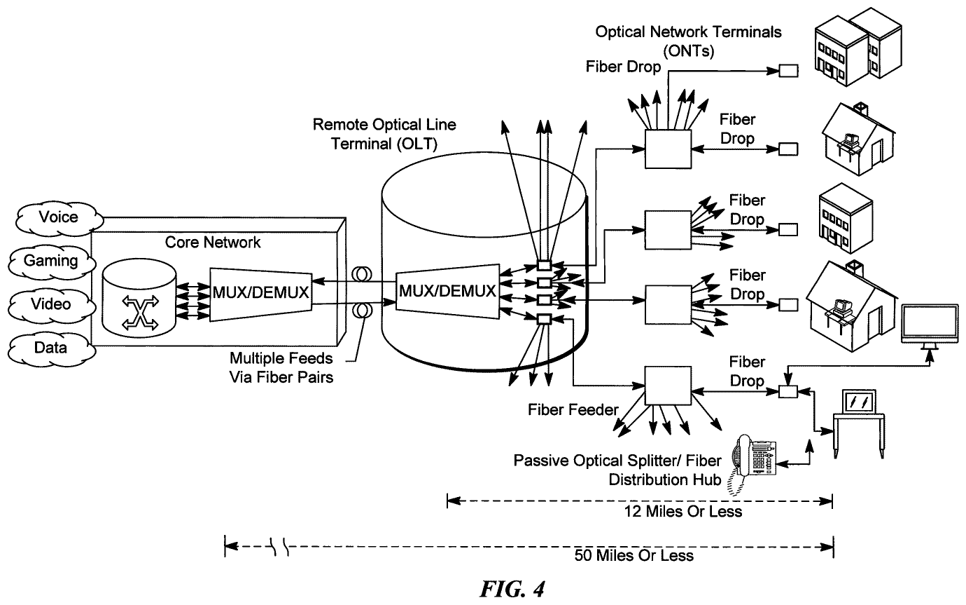

Referring to FIG. 4, it is often desirable in some installations to locate the optical line terminal at a location remote from the core network, generally referred to as a remote optical line terminal (OLT). The remote OLT may include one or more feeds from the core network to the remote OLT. The remote OLT may then distribute data to a plurality of ONTs and receive data from the plurality of ONTs. Each of the ONTs in turn provides data to and receives data from customer devices. The remote OLT typically has the capability of providing services to a few hundred to a few thousand ONTs.

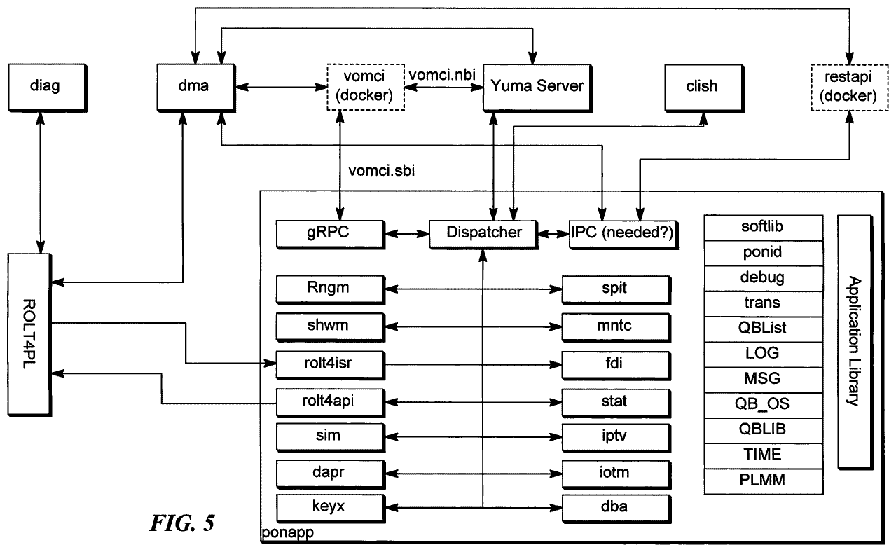

Referring to FIG. 5, an exemplary OLT, which may include a local or a remote OLT, is illustrated. By way of example, a diag process, a dma process, a clish process, a restapi process, a gRPC process, a rolt4isr process, and/or a rolt4api process are preferably included locally on the OLT. Also, a dynamic bandwidth allocation process which allocates available bandwidth among to each of the ONTs is likewise included locally on the OLT. Other processes associated with the remote OLT, such as the vomci and/or Yuma server may be virtualized and located on a cloud based server. For example, the VOMCI may (1) receive service configurations from a virtual OLT management function, (2) translate the received configurations into ITU G.988 OMCI management entities and formatting them into OMCI messages, (3) encapsulating and sending formatted OMCI messages to and from a VOMCI proxy, (4) translating the OMCI messages (presenting ONT's operational data) received from the vOMCI proxy into data (e.g., notifications acknowledges, alarms, PM registers) understandable by the vOLT management function, and/or (5) sending the above ONT operational data to the vOLT management function. See, TR-451 vOMCI Specification, June 2022 and ONT management and control interface (OMCI) specification, G.988, November 2017, both of which are incorporated by reference herein in their entirety. See, TR-385 ITU-T PON YANG Modules, October 2020, incorporated by reference herein in its entirety. See, TR-383 Common YANG Modules for Access Networks, March 2022, incorporated by reference herein in its entirety.

By way of example, the gRPC provides gRPC server and client layer to interface with multiple vomci agents which may be providing vomci services to the ROLT.

By way of example, the dispatcher provides a messaging pathway between components within the ponapp. Local microservices may register callbacks for message ids which is part of the MSG layer. Any microservice can route to another based on the top 2 bytes of a message id that indicates the destination.

By way of example, the IPC provides TCP and UDP sockets for relaying messages to and from the application in the MSG lib format, and works side by side with the dispatcher.

By way of example, the mgm is a ranging manager that provides the state machine and local for the physical layer management of the ONT. This includes an auto discovery process, the ranging of an ONT, drift management, and LOS handling.

By way of example, the shwm is a shelf manager task that handles any devices that are outside of the rolt4api/rolt4isr domain.

By way of example, the rolt4isr is a handler for incoming interrupts from the PL.

By way of example, the rolt4api handles requests from various microservices in the ponapp to program or interact with the ROLT.

By way of example, the sim provides simulations services to provide the ability to sim-ulate devices that may not be physically present.

By way of example, the spit is a smartcard proxy interface task that provides server for application requests coming in or out of the ponapp. A typical path would be from an outside client via IPC via dispatcher into the spit. The SPIT may then relay to other microservices to perform the requested task. Some provisioning may go via the softlib DB and will be further re-layed as a provisioning callout.

By way of example, the mntc is a maintenance state machine which is preferably an event drive state machine for ONTs.

By way of example, the fdi is a fault detection and isolation task as a hierarchical alarm tree service to track alarm conditions for different equipment types.

By way of example, the stat is a statistics manager that handles polling of on board statistics and aggregation of statistics for other calling functions.

By way of example, the iptv provides IPTV services, including IGMP snooping/proxy support.

By way of example, the dapr is a destination address programmer that handles un-known upstream source mac addresses for N:1 connections. This may maintain the mac for-warding table in the PL as well as pruning out aged mac addresses.

By way of example, the iotm is an IOT (aka ONT) manager that suppors directives for the ONT.

By way of example, the dba is a dynamic bandwidth allocation.

By way of example, the keyx is a key exchange task that handles key exchanging for ONTs.

By way of example, the softlib is a soft DB library implemented as a memory based database used to contain configurations of the ROLT.

By way of example, the ponid is a library used to associate ITUT serial numbers with ONT ids and/or channel assignment.

By way of example, the debug is a debug library.

By way of example, the trans is a transaction library used for transactional and state based requests for microservices.

By way of example, the QBList is a library of various list and vector functions.

By way of example, the LOG is an event log.

By way of example, the MSG is a message library.

By way of example, the QB_OS is an operating system library.

By way of example, the QBLIB is a library for local APIs.

By way of example, the TIME is a timer library used for time based callback logic.

By way of example, the PLMM is a ploam message library used for the encoding and decoding of ploam messages on the pon.

The core network and/or the optical line terminals provides management and control functionality over the ONT by using an optical network unit management and control interface (OMCI). The core network 200 and the OLT 210 with which it provides data to and receives data from, transmits data and receives data using a PON protocol over an optical distribution network (e.g., optical splitters, etc.) 220. The OLT 210 passes data through the optical distribution network (ODN) 220 to the ONTs 230, and receives data through the optical distribution network (ODN) 220 from the ONTs 230. The OMCI messages between the ONT 210 and the ONUs 230 for management and control are likewise provided between the OLT 210 and the ONTs 230 through the ODN 22. The ONTs 230 provides access network line termination, a user network interface line termination for subscriber devices, and service multiplexing and de-multiplexing for subscriber devices.

The configuration management provides functions to identify the ONTs capabilities and to exercise control over the ONTs. The areas of management for the ONTs include configuration of, (1) equipment, (2) passive optical network and reach extender protection, (3) the user network interfaces, (4) Gigabit-capable passive optical network Encapsulation Method port network contention termination points; (5) interworking termination points; (6) operations, administration, and maintenance flows, (7) physical ports, (8) Gigabit-capable passive optical network Encapsulation Method adaptation layer profiles, (9) service profiles, (10) traffic descriptors, and (11) asynchronous transfer mode adaptation layer profiles. As modelled by the OMCI, the ONT detects and reports equipment, software, and interface failures and declares the corresponding alarms. The ONTs may be considered as managed entities by the exchange of information between the OLT and the ONT, based upon the OMCI messages for optical access networks.

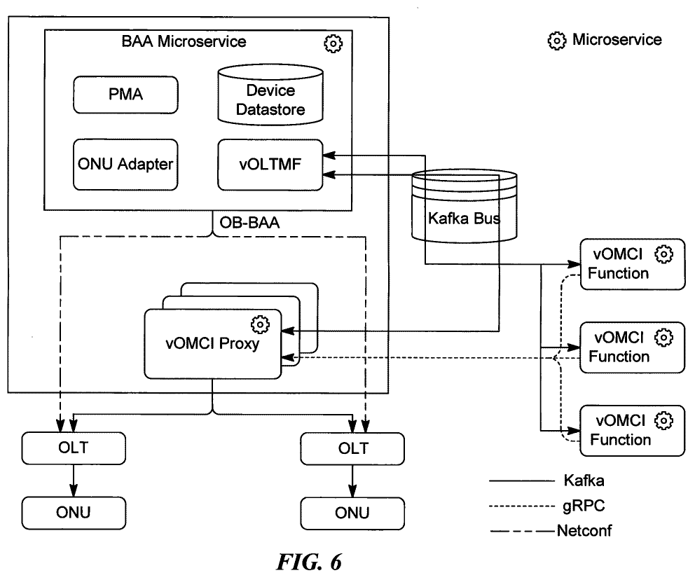

Referring to FIG. 6, a high-level design of a vOLT Management Function (vOLTMF) that may be used to manage ONTs through vOMCI messages is illustrated. There is communication between the vOLTMF, vOMCI Proxy, and vOMCI function based upon creating and deleting ONTs, receiving ont-state-change notifications, and sending requests to ONTs. The vOLTMF manages ONTs through a ONT adapter that may be deployed as broadband access abstraction, the association of which is based on the model, type, vendor, and version mentioned while creating the ONT. The ONT adapter may use a library of the YANG modules for ONTs that the vOLTMF refers to for handling ONT requests, responses, and notifications from external management systems.

The vOLTMF performs actions upon receiving notifications and requests either from an OLT device or other components within the broadband access abstraction core. For example, the onu-state-change notification that is sent by the OLT device on its Northbound Interface (NBI) that is received by broadband access abstraction core. The broadband access abstraction core propagates the notification towards vOLTMF and broadband access abstraction NBI so that it can be handled by the Access SDN M&C.

Upon reception of the notification, the vOLTMF processes the notification, checks if a preconfigured ONU device exists and authenticates the ONU, the vOLTMF transforms the notification to Google Protobufs (GPB) format and propagates the set-onu-communication Action towards the vOMCI function and vOMCI-proxy via the Kafka bus.

All the YANG requests are sent towards the vOMCI function and vOMCI Proxy via the Kafka bus in GPB format. Once the vOMCI function/Proxy processes the requests, the vOMCI function sends the notification/request response in GPB format back to the vOLTMF via the Kafka bus and the response is received through the KafkaNotificationCallback#onNotification().

Upon receiving the response, the vOLTMF is responsible for processing the response and performs actions accordingly.

There could be multiple interactions between the vOLTMF and the vOMCI function including parallel configuration requests/commands for either the same or different ONUs. These interactions are parallel and asynchronous such that the requests are not idle/blocked while waiting for responses because the vOLTMF has separate task queues and threadpools to handle the request/response interactions. The following shows the list of vOLTMF threadpools that spawned as new Runnable tasks, namely, processNotificationRequestPool, kafkaCommunicationPool, kafkaPollingPool, processNotificationResponsePool, and processRequestResponsePool. processNotificationRequestPool is used for processing the mediated device event listener callbacks and device notification requests. kafkaCommunicationPool is used to process individual GET/COPY-CONFIG/EDIT-CONFIG requests inside a MediatedDeviceNetconfSession spawned by preocessRequestResponsePool. kafkaPollingPool is used to tart up the Kafka-Consumer implementation and polling for responses from vOMCI-function/vOMCI Proxy. processRequestResponsePool is used for processing notification responses from the vOMCI-function/vOMCI Proxy. The processRequestResponsePool is used for processing GET/COPY-CONFIG/EDIT-CONFIG requests and responses from the vOMCI-function/vOMCI Proxy. In general, the process may be considered a type of protocol adapter to one that operates on an ONT that also works with an OLT in a PON environment. As it may be observed, the manner in which the processing is performed is relatively complex, including Google Protobufs, remote procedure calls, and other complications that require a substantial amount of computational resources to process all the microservices which are burdensome for the OLT.

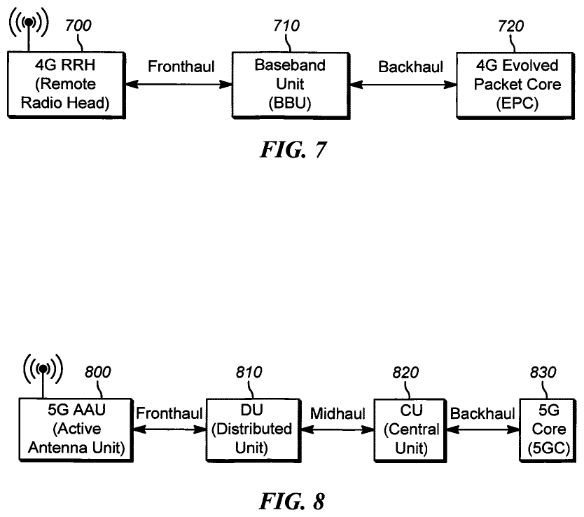

Referring to FIG. 7, for wireless based networks, such as a 4G cellular network, a 4G remote radio head 700 sends and receives wireless signals to other devices, such as mobile devices (e.g., iPhone). The remote radio head 700 is interconnected to a baseband unit 710. The data interconnection between the remote radio head 700 and the baseband unit 710 is referred to as fronthaul. The remote radio head 700 remains at the cellular site with the antenna. The baseband unit 710 is located at a more centralized location to serve multiple remote radio heads 700. Each of the baseband units 710 is interconnected to an evolved packet core 720. The interconnection between the baseband unit 710 and the evolved packet core 720 is referred to as back-haul. Fronthaul and backhaul both play a part in connecting the end user or node to a network. A primary difference between fronthaul and backhaul is the part of the network the technology it is deployed on. Backhaul links the mobile network to the wired network, while fronthaul describes the network architecture that connects the remote cell sites to the baseband unit. In particular, the backhaul gets data from a remote location to a major network, such as the Internet or an enterprise network. 4G networks often are based upon a common public radio interface protocol.

Referring to FIG. 8, for wireless based networks, such as a 5G cellular network, a 5G active antenna unit 800 sends and receives wireless signals to other devices, such as mobile devices (e.g., iPhone). The active antenna unit 800 is interconnected to a distributed unit 810. The data interconnection between the active antenna unit 800 and the distributed unit 810 is referred to as fronthaul. The active antenna unit 800 remains at the cellular site with the antenna. The distributed unit 810 is located at a more centralized location to serve multiple remote radio heads 700. The distributed unit 810 is typically deployed on a server. The distributed unit 810 is normally deployed close to the active antenna unit 800 and it runs the RLC, MAC, and parts of the PHY layer. Each of the distributed units 810 is interconnected a central unit 820. The data interconnection between the distributed unit 810 and the central unit 820 is referred to as mid-haul. The central unit, typically includes RRC, SDAP, and PDCP protocol layers, and is mainly responsible for non-real-time RRC, PDCP protocol stack functions. The central unit is often deployed on a server to support the integrated deployment of core network UPF sinking and edge computing. The central unit 820 and the distributed unit 810 may be connected through a F1 interface. The central unit 820 may manage one or more distributed units 810. The central unit 820 is interconnected to the 5G Core 830 using a backhaul interconnection. 5G networks often are based upon an open radio access networks (ORAN) protocol, which may be a serial type interface.

Unlike the midhaul and backhaul interconnections, the fronthaul interconnection, especially for 4G and 5G, includes timing considerations for signaling that passive optical networks are not inherently considered to support. For example, the handshaking between the user device and the baseband unit/4G evolved packet core/distributed unit/central unit/5G core have strict tolerances for a user device to initially access the cellular network. In this manner, the user device may make a request for access and if the response of a grant of access is to slow, the user device may make a new request for access, and if the response of a grant of access is to slow, the user device may make a new request for access, and so forth, thereby inhibiting the ability to effectively access the cellular network. Accordingly, if such timing considerations are not guaranteed or otherwise unlikely to occur on a regular basis, then PON is not especially suitable for the latest generation of cellular networks.

After consideration of cellular networks, one type of message is random-access channel (RACH) which is a shared channel used by wireless terminals to access the mobile network (TDMA/FDMA, and CDMA based network) for call set-up and bursty data transmission. Whenever a device wants to make an MO (Mobile Originating) call it schedules the RACH. RACH is transport-layer channel; the corresponding physical-layer channel is PRACH. A typical feature of a random-access channel is that messages are not scheduled (compared to, for example, a “dedicated channel” in UMTS, which is assigned exclusively to one user at a time).

After consideration of cellular networks, another type of message is a hybrid automatic repeat request (hybrid ARQ or HARQ) that is a combination of high-rate forward error correction (FEC) and automatic repeat request (ARQ) error-control. In standard ARQ, redundant bits are added to data to be transmitted using an error-detecting (ED) code such as a cyclic redundancy check (CRC). Receivers detecting a corrupted message will request a new message from the sender. In Hybrid ARQ, the original data is encoded with a FEC code, and the parity bits are either immediately sent along with the message or only transmitted upon request when a receiver detects an erroneous message. The ED code may be omitted when a code is used that can perform both forward error correction (FEC) in addition to error detection, such as a Reed-Solomon code. The FEC code is chosen to correct an expected subset of all errors that may occur, while the ARQ method is used as a fall-back to correct errors that are uncorrectable using only the redundancy sent in the initial transmission. As a result, hybrid ARQ performs better than ordinary ARQ in poor signal conditions, but in its simplest form this comes at the expense of significantly lower throughput in good signal conditions. There is typically a signal quality cross-over point below which simple hybrid ARQ is better, and above which basic ARQ is better. By way of example, HARQ is used in HSDPA and HSUPA which provide high speed data transmission (on downlink and uplink, respectively) for mobile phone networks such as UMTS, and in the IEEE 802.16-2005 standard for mobile broadband wireless access, also known as “mobile WiMAX”. It is also used in Evolution-Data Optimized and LTE wireless networks.

By way of example a HARQ procedure during an uplink transmission may include the user equipment sending data in the uplink through PUSCH and the eNB determines its correcting using crc and informs the user equipment about the ACK/NACK. eNodeB (e.g., radio unit) sends ACK/NACK through PHICH. Each HARQ processes use round robin fashion to transmit HARQ, hence, each transmission and re-transmission may be determined from SFN and SF. The user equipment does not need to send information of RV (synchronous HARQ). The uplink can use adaptive or non-adaptive re-transmission. In adaptive uplink transmission, MICS and RV are determined from DCI 0. In non-adaptive uplink transmission, the transmission attributes remain same as in the previous transmission. TV are assigned according to a predefined sequence—0, 2, 3, 1. Variable CURRENT-IRV is an index into this sequence. When eBN does not send a DCI 0 but sends a NACK on PHICH, then the user equipment performs non-adaptive re-transmission.

A device may use RACH and/or HARQ messaging (or other suitable messaging depending on the network architecture) to establish a connection between the device and the mobile network, with relatively tight timing tolerances, where PON is used as a transport mechanism for the fronthaul that is modified to accommodate the stricter tolerances.

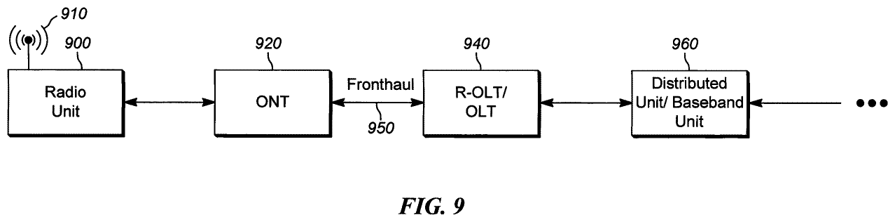

Referring to FIG. 9, a radio unit 900 receives messages from its associated antenna 910. The radio unit 900 inspects each of the received messages and tags or otherwise identifies each of the messages that correspond to a RACH and/or a HARQ message (or other suitable messages depending on the network architecture). An ONT 920 may receive the messages, including those messages that are identified as RACH and/or HARQ messages, for transmission using a passive optical network based protocol to one or more destinations, such as a remote-OLT/OLT 940. The remote-OLT/OLT 940 may provide the received data to a distributed unit or a baseband unit 960, that may include the associated remote-OLT/OLT 940, across a fronthaul interconnection 950.

The distributed unit or a baseband unit 960 receives messages from its associated central unit/evolved pack core (or otherwise). The distributed unit or a baseband unit 960 inspects each of the received messages and tags or otherwise identifies each of the messages that correspond to a RACH and/or a HARQ message (or other suitable messages depending on the network architecture). The remote-OLT/OLT 940 may receive the messages, including those messages that are identified as RACH and/or a HARQ messages, for transmission using a passive optical network-based protocol to its destination, such as the ONT 920 across the fronthaul interconnection 950. The ONT 920 may provide the received data to the radio unit 900 which broadcasts the data using the associated antenna 910.

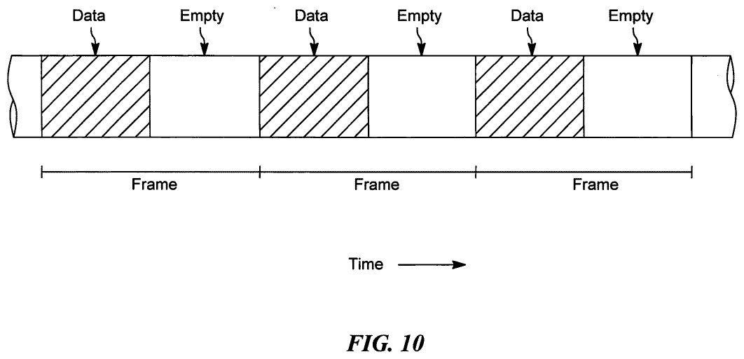

Referring to FIG. 10, the traditional manner of transmitting PON data within a frame includes accumulating data to be transmitted at the start of the next frame, transmitting the data at the start of the next frame until the data has been transmitted, waiting for the subsequent frame to start while accumulating more data that is then transmitted starting in the subsequent frame, transmitting the data at the start of the subsequent frame until the data has been transmitted and so forth. There is also the time delay related to requests and grants. As it may be observed, the frames tend to be front loaded with the transmitted data and the later portions of the frames tend to be empty.

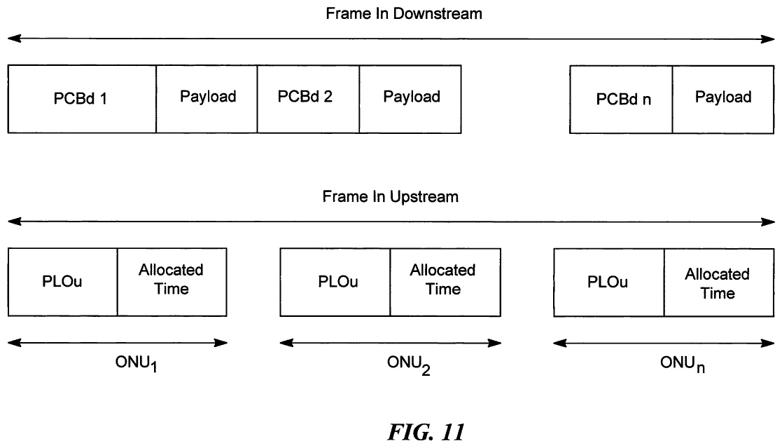

Referring to FIG. 11, frames that are broadcast in the downstream direction travel to all end units. However, each of the end units must only accept frames that are intended for the end unit, which is ensured by the unique identifiers that are contained within the frame. Therefore, the data are processed only by the unit for which the data were determined. Time division multiplexing is often used for the upstream direction.

Frames in the downstream direction are composed of a physical control block downstream (PCBd). The length of the PCBd header is the same size for all transmission rates. If no data is requested for sending, the frames are forwarded in the downstream direction; the PCBd is also used for time synchronization.

In the upstream direction, time division multiple access techniques are typically used. By using this technique, the OLT assigns variable time intervals to the ONTs. The intervals are primarily used to synchronize the clustering of data that are transmitted in the upstream direction.

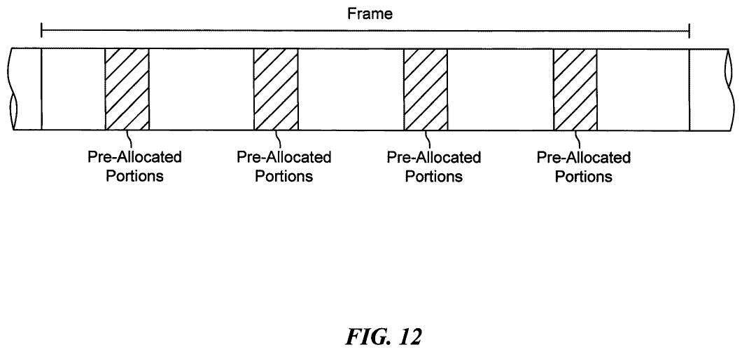

Referring to FIG. 12, when PON is used in the environment of a fronthaul interconnection, there is typically only one, or a limited number of, receiving devices for the data. In this environment, the fronthaul interconnection is more akin, in many implementations, as a point-to-point interconnection. With such a realization, it was determined that the frame could include a plurality of pre-allocated portions (e.g., payloads and allocated time) in the downstream direction and/or the upstream direction that are spaced apart from one another. Each of the pre-allocated portions may include the appropriate destination signalling, as appropriate. The data payload for each of the pre-allocation portions is limited to only including selected messaging such as the RACH message and/or the HARQ message (or other suitable messages depending on the network architecture). Other types of messages, such as those including general data, such as video streaming data or audio streaming data, is prohibited from using the pre-allocated portions.

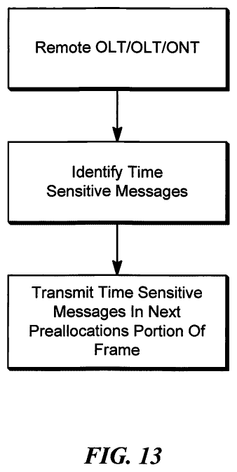

Referring to FIG. 13, the remote-OLT/OLT and/or ONT receives messages to be transmitted for a subsequent frame and identifies those that are especially time sensitive, such as the RACH message and/or the HARQ message. The time sensitive messages are transmitted in the next available pre-allocated portions of the current frame being transmitted, rather than waiting for a subsequent frame to transmit the messages. Accordingly, as the RACH messages and/ or the HARQ messages are received, they may be transmitted without substantial temporal delay because the time slots for such transmission are already allocated. Also, with the pre-allocated portions of the current frame spaced out across a frame, the temporal delay is further reduced because the transmission does not need to wait for a subsequent frame. Further, when the RACH messages and/or the HARQ messages are received while the current frame is being transmitted, they may be sent within the current frame by making use of the pre-allocated portions of the current frame. It is noted that the pre-allocation of portions of the current frame by the remote-OLT / OLT is not in the response to a request to send data. It is noted that the pre-allocation of portions of the current frame by the ONT is not in the response to a request to send data. In this manner, there is no need for the request and grant process for the pre-allocated portions. By way of example, for the ONTs the pre-allocation may be provided in the form of pre-allocation of portions of the bandwidth map provided to the ONT, even when currently there is no such RACH messages and/or HARQ messages to be transmitted during those portions. Also, if the ACK message is late, it could result in the re-transmission of data, which tends to slow down the effective throughput of data through the system.

In another embodiment, the remote-OLT/OLT/ONT may pre-allocate bandwidth for data prior to the data being available at the remote-OLT/OLT/ONT. This pre-allocation may be based upon information included within the cellular messages, including cellular messages that are related to a particular user. In this manner, for example, the remote-OLT/OLT/ONT may be able to predict a stream of data is going to be provided to a particular user, and therefore allocate bandwidth for such data prior to dynamic bandwidth allocation by the remote-OLT/OLT/ONT.

Other types of messages that may be prioritized, which are generally limited in their usage of available bandwidth, include monitoring messages, maintenance messages, and control messages. One such message is a “Dying Gasp Message” which typically indicates a device (cellular and/or PON) has lost power. Another such message are power level messages of the optical signals, typically send by the remote-OLT, OLT, and/or ONT.

Within a cellular network, there are logical channels on the fronthaul for the transmission of data. A channel containing user data may include HARQ based messages, such as PDSCH (physical shared channel for LTE) for downstream and PUSCH (physical shared channel for LTE) for upstream. Upon further consideration it was determined that another source of such HARQ messages are control channels, such as PHICH (physical channel hybridARQ indicator channel for LTE). Accordingly, the prioritization provided by the remote-OLT/OLT/ and/or ONT should take into account multiple potential sources for such HARQ based messages.

Traditionally, a landline based telecommunication network includes switched wired interconnections where telephones are wired directly into a public switched telephone network. A pair of telephones may be used to place a call between two different people by dialing a phone number for voice based calls. Such landline based telecommunication networks are constructed with a goal that all of the subscribers may simultaneously use the system and that none of the connections as a result are dropped because of the perceived importance of voice calls. Most of the time the landline based telecommunication network will have excess capacity, but such an overcapacity supports the ability for provide quality voice service for all the subscribers simultaneously.

For cellular based communications, which includes a wireless interconnection, was initially intended to provide voice calls over the cellular network. With the legacy being landline-based telecommunications, the cellular based communications were designed such that a voice call can be placed at any time in a guaranteed manner if there is a sufficiently close cellular base station that will accept the connection. Once the connection is made to the cellular base station, the voice call is expected to be completed and have quality voice service. To provide such guaranteed quality voice service, the fronthaul, mid-haul, and backhaul (collectively referred to as the “x-haul”) interconnection are designed to ensure that a maximum number of users may simultaneously make a connection to the cellular base station and have sufficient bandwidth to provide guaranteed data connectivity through the x-haul. Most of the time the x-haul portion of the cellular network will have excess capacity, but such an overcapacity supports the ability for provide quality voice service for all the subscribers simultaneously.

Passive optical networks, hybrid-fiber coaxial DOCSIS based networks, or otherwise, provide data interconnectivity for a subscriber, typically to the Internet. Each of the subscribers may be provided a non-guaranteed maximum bandwidth. The available bandwidth of the system is typically substantially less than total of the non-guaranteed maximum bandwidth of all of the subscribers. Most of the time only a limited number of the subscribers are using the network, and of those subscribers only a limited number are using near the non-guaranteed maximum bandwidth allocated to them. In this manner, the overall bandwidth is shared among the subscribers. In many cases, the oversubscription of the bandwidth for such networks may be as high as 100 to 1.

The evolution of cellular networks supports data communications in addition to voice-based communications, such Internet browsing, video streaming, audio streaming, or otherwise. With this mixture of voice and data communications using cellular networks, at least for the data-based communications it is not as essential to provide guaranteed bandwidth because any lost data communications tend to be retransmitted in an automated manner that is transparent to the subscriber. However, for the voice-based communications, it is desirable that guaranteed bandwidth exists sufficient to ensure that the voice call has a sufficiently high quality of service. As a result of such a mix of data and voice-based communications, it is desirable to include over-subscription of x-haul based cellular communications because at least a portion of the communications, namely the data-based communication, is suitable for retransmission if data is dropped without significantly impacting the subscriber's experience. Accordingly, the bandwidth capabilities of the x-haul interconnection may be designed to have substantially less bandwidth capabilities than the maximum bandwidth capabilities of the corresponding radio unit and/or radio units with a maximum number of subscribers interconnected thereto.

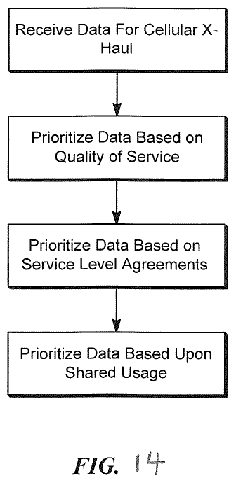

Referring to FIG. 14, a modified x-haul network may include a passive optical network-based interconnection, such as one or more remote-OLTs/OLTs and one or more ONTs to transmit data between the radio unit and the core. In this manner, the passive optical network may be used for the transportation of data (including voice data) across cellular x-haul. The remote-OLT/OLT preferably includes a prioritization of the data to be transmitted across the x-haul network (or portions thereof). The prioritization should initially be based upon the desired quality of service, such as voice having the highest quality of service. In this manner, data that corresponds to voice calls has a high priority so that in a manner akin to traditional cellular networks and landline-based networks, voice calls that are placed are not interrupted. Additional high quality of service-based data may likewise be prioritized in comparison to other data. The quality of service for data and/or voice data may be determined by inspection of the data at the packet level.

The prioritization should next be based upon a particular service level agreement associated with the particular subscriber's data. Data associated with a higher service level agreement should be prioritized over data associated with a lower service level agreement. By way of example, if a subscriber has a service level agreement with 300 MBits/second guaranteed bandwidth, that should take priority over a subscriber with 300 MBits/second non-guaranteed bandwidth. The service level agreement for data may be determined by inspection of the data at the packet level.

The prioritization should next be based upon a shared usage of any additional bandwidth among the subscribers. In this manner, in general additional bandwidth is made available to remaining data in a non-discriminatory manner.

Over time, the cellular network providers upgrade their network technology, such as supporting existing 4G cellular technology, and over time, also supporting 5G cellular technology, and over time, also supporting 6G cellular technology, and so forth. In general, 4G cellular technology has relatively lower bandwidth and timing requirements with respect to 5G cellular technology, which in turn, has relatively lower bandwidth and timing requirements with respect to 6G cellular technology, and so forth. Also, it is desirable that the same access network is used for transporting the data for the 4G, 5G, 6G, etc., cellular radio units to the core networks, though fronthaul, mid-haul, and/or backhaul, as appropriate. It is further desirable that the fronthaul, mid-haul, and/or backhaul of 4G (or other) between different components may be mixed with the fronthaul, mid-haul, and/or backhaul of 5G (or other) for added flexibility.

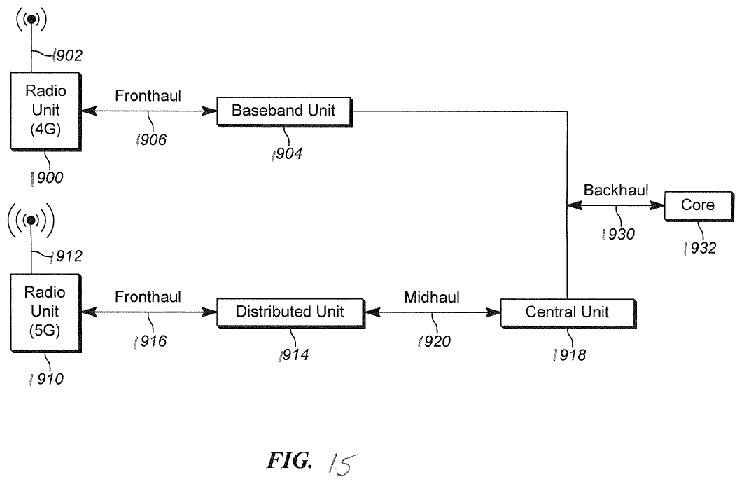

Referring to FIG. 15, a radio unit 1900 suitable for 4G sends and receives messages to and from its associated antenna 1902 suitable for 4G. The radio unit 1900 may provide and receive data to and from a baseband unit 1904 across a fronthaul interconnection 1906. A radio unit 1910 suitable for 5G sends and receives messages to and from its associated antenna 1912 suitable for 5G. The radio unit 1910 may provide and receive data to and from a distributed unit 1914 across a fronthaul interconnection 1916, which in turn provides and receives data to and from a central unit 1918 across a mid-haul interconnection 1920. The baseband unit 1904 provides and receives data to a core 1932 over a backhaul interconnection 1930. The central unit 1918 provides and receives data to the core 1932 over the backhaul interconnection 1930. The core 1932 may be a core suitable for both 4G and 5G interconnections, or otherwise the core 1932 may have a core suitable for 4G and a core suitable for 5G. In this manner, both the 4G and the 5G data traffic is provided across the same backhaul interconnection 1930.

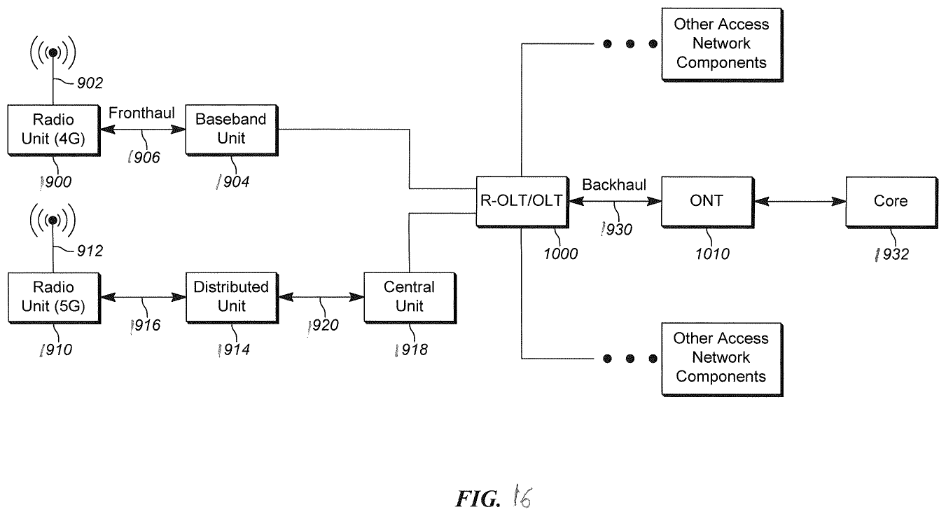

Referring to FIG. 16, it is desirable to include a passive optical network interconnection to provide the fronthaul, mid-haul, and/or backhaul interconnection. A ONT 1000 provides and receives data from a corresponding remote-OLT/OLT 1010. In this manner, the data from the radio units 1900, 1910 is provided across the backhaul 1930 to the remote-OLT/OLT 1010. In this manner, the data from the core 1932 is provided to the remote-OLT/OLT 1010 which is provided across the backhaul 1930 to the ONT 1000. The ONT 1000 may be interconnected with other access network components, such as other ONTs, other radio units, other devices that send and receive data to the core, etc. In this manner, the access network through the remote-OLT/OLT 1000 may use the backhaul 1930 for other data traffic.

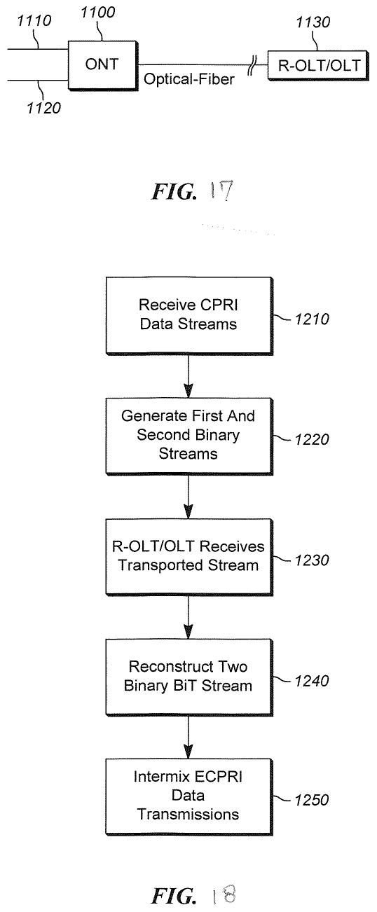

Referring to FIG. 17, the ONT 1100 may be positioned at any suitable location, such as at a location suitable to carry 4G fronthaul, midhaul, and/or backhaul data traffic. The ONT may be also positioned at any suitable location, such as at a location suitable to carry 5G fronthaul, midhaul, and/or backhaul data traffic. In this manner, the ONT 1100 may be positioned in a location that preferably carries 4G based CPRI data traffic 1110 and 5G based eCPRI data traffic 1120 over the same passive optical network-based interconnection. See ePRI Specification V7.0, Sep. 10, 2015, Interface Specification, Common Public Radio Interface: (CPRI) Interface Specification, incorporated by reference herein. eCPRI is a protocol that is based upon the use of Ethernet frames. See eCPRI Specification V2.0, Oct. 5, 2019, Interface Specification, Common Public Radio Interface: eCPRI Interface Specification, incorporated by reference herein. The ONT 1100 includes an Ethernet based receiver to receive the Ethernet frames and provide such data in the form of passive optical network-based protocols to a corresponding OLT 1130.

CPRI is a protocol that is more analog in nature, where in the baseband, is provided in the form of two binary bit streams where the phase of the two binary streams are offset by 90 degree. In many cases, for 4G based communications the content of the CPRI data streams is proprietary in nature, and varies from manufacturer to manufacturer. With the CPRI data not generally being packet based, but rather a stream of data across two binary bit streams, it is desirable for the ONT 1100 to provide the CPRI data in some manner on the optical fiber to the OLT 1130 in a timely manner along with the eCPRI data.

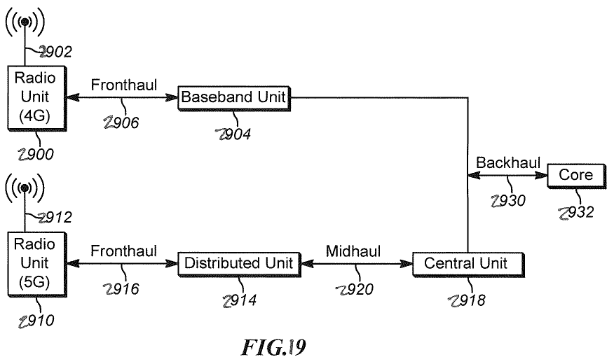

Referring to FIG. 18, the ONT 1100 may receive the CPRI data stream including the two binary bit streams 1200 at an input thereof. The ONT 1100 then generates a first binary data stream and second binary data stream 1210 for each of the two binary bit streams 1200. In some cases, the two binary streams may be mixed together, while logically they remain two binary streams. The ONT 1100 then transmits 1220 the first binary stream and the second binary data stream 1210 in the form of passive optical network-based frames to the remote-OLT/OLT 1130. The remote-OLT/OLT 1130 receives the passive optical network-based frames 1230. The remote-OLT/OLT 1130 reconstructs the CPRI data stream including the two binary bit streams 1240. The reconstructed CPRI data stream is reconstructed in a manner that maintains the phase information of the two data streams. In addition to transmitting the CPRI data, the ONT 1100 also transmits the eCPRI data between frames of CPRI data 1250. In this manner, the ONT in combination with the remote-OLT/OLT passes the CPRI data in a transparent manner.

The nature of the CPRI data is akin to a real-time data stream where it transmits data in a continuous stream of data and the remote-OLT/OLT likewise needs to transmit the data in a continuous stream of CPRI data without interruptions. To achieve a continuous stream of CPRI data the buffer at the remote-OLT/OLT needs to be maintained at a sufficient level such that it does not empty its buffer if the transmission of CPRI data from the ONT is temporarily interrupted, thus resulting in an interruption of the CPRI data transmission from the remote-OLT/OLT. The remote-OLT/OLT may send control information to the ONT to manage the amount of CPRI data that is being transmitted to the remote-OLT/OLT, especially in the case that the buffer at the remote-OLT/OLT becomes too low or too high.

The remote-OLT/OLT may fail to receive data provided by the passive optical network-based frames or otherwise the data is corrupted. In this case, the remote-OLT/OLT may send a request to the ONT to retransmit the missing or otherwise corrupted data. In response, the ONT retransmits the data to the remote-OLT/OLT which is then temporally positioned in the CPRI data stream in a manner that is transparent to the retransmission by the ONT. This technique of retransmission by the ONT at the request of the remote-OLT/OLT, reduces the amount of missing or otherwise corrupted data being provided by the remote-OLT/OLT. It is noted that the ONT should maintain data in its buffers after being transmitted, so that it is available for a sufficient time thereafter in the event the data needs to be retransmitted.

In some configurations, the ONT may use a single port for the CPRI data that receives the first and second bit streams together with a control bit stream.

In some configurations, the ONT may use a pair of ports for the CPRI data that receives the first and second bit streams together with a control bit stream, where two of the bit streams are received on a first port and the other is received on the second port.

In some configurations, the ONT may use three ports for the CPRI data that receives the first and second bit streams together with a control bit stream, where each of the bit streams are received on a different port.

The ONT may receive configuration information so that it may determine what data is being received on each of the ports, in the case of multiple ports. Also, the ONT may receive configuration information regarding the phase between the different singles being received on each of the ports, in the case of a single or multiple ports.

In addition, a corresponding process may be used to modify CPRI data by the remote-OLT/OLT, transmit the data to the ONT, and the ONT reconstruct the CPRI data, and transmit the CPRI data as a pair of bit streams offset by 90 degrees with respect to one another.

Over time, the cellular network providers upgrade their network technology, such as supporting existing 4G cellular technology, and over time, also supporting 5G cellular technology, and over time, also supporting 6G cellular technology, and so forth. In general, 4G cellular technology has relatively lower bandwidth and timing requirements with respect to 5G cellular technology, which in turn, has relatively lower bandwidth and timing requirements with respect to 6G cellular technology, and so forth. Also, it is desirable that the same access network is used for transporting the data for the 4G, 5G, 6G, etc., cellular radio units to the core networks, though fronthaul, mid-haul, and/or backhaul, as appropriate. It is further desirable that the fronthaul, mid-haul, and/or backhaul of 4G (or other) between different components may be mixed with the fronthaul, mid-haul, and/or backhaul of 5G (or other) for added flexibility.

A further consideration of typical 4G networks includes the fronthaul interconnection often using a common public radio interface (CPRI) between the radio unit and the baseband unit, typically at the bottom of a radio tower. A backhaul interconnection between the baseband unit and the core network has relatively low bandwidth requirements, such as around 350 MBits/second. When adding 5G service to the same radio tower, it is often desirable to use the same backhaul interconnection to also carry 5G data from the distributed unit and/or central unit to the core, which has relatively higher bandwidth requirements, such as around 10 GBits/second (approximately 30 times greater). In this manner, the same backhaul interconnection should support both 4G data and 5G data in an effective manner.

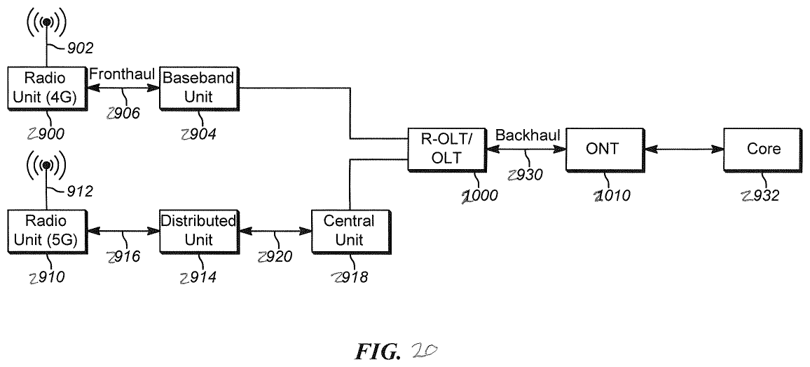

Referring to FIG. 19, a radio unit 2900 suitable for 4G sends and receives messages to and from its associated antenna 2902 suitable for 4G. The radio unit 2900 may provide and received data to and from a baseband unit 2904 across a fronthaul interconnection 2906. A radio unit 2910 suitable for 5G sends and receives messages to and from its associated antenna 2912 suitable for 5G. The radio unit 2910 may provide and receive data to and from a distributed unit 2914 across a fronthaul interconnection 2916, which in turn provides and receives data to and from a central unit 2918 across a mid-haul interconnection 2920. The baseband unit 2904 provides and receives data to a core 2932 over a backhaul interconnection 2930. The central unit 2918 provides and receives data to the core 2932 over the backhaul interconnection 2930. The core 2932 may be a core suitable for both 4G and 5G interconnections, or otherwise the core 2932 may have a core suitable for 4G and a core suitable for 5G. In this manner, both the 4G and the 5G data traffic is provided across the same backhaul interconnection 2930.

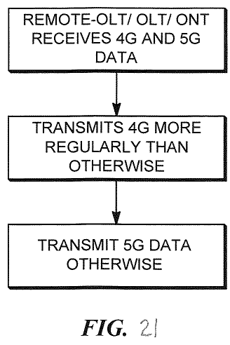

Referring to FIG. 20, it is desirable to include a passive optical network interconnection to provide the backhaul interconnection. A remote-OLT/OLT 2000 provides and receives data from a corresponding ONT 2010. In this manner, the data from the radio units 2900, 2910 is provided across the backhaul 2930 to the ONT 2010. In this manner, the data from the core 2932 is provided to the ONT 2010 which is provided across the backhaul 2930 to the remote-OLT/OLT 2000. After further consideration it was determined that as a result of the differences in data rates between 4G and 5G, the 5G data is likely to swamp out the timely delivery of the 4G data because of the time required to fill up various buffers in the remote-OLT/OLT 2000 and/or the ONT 2010 which typically occurs before data is transmitted. In particular, from the perspective of the remote-OLT/OLT 2000 and/or the ONT 2010, there is often a higher bandwidth 5G data stream and a lower bandwidth 4G data stream, where the 5G data stream has a tendency to be filling up the respective buffers necessitating the transmission of the 5G data to empty its buffers at the expense of the transmission of the 4G data. The delays in the transmission of the 4G may result in a derogation of quality, especially in the case of voice calls.

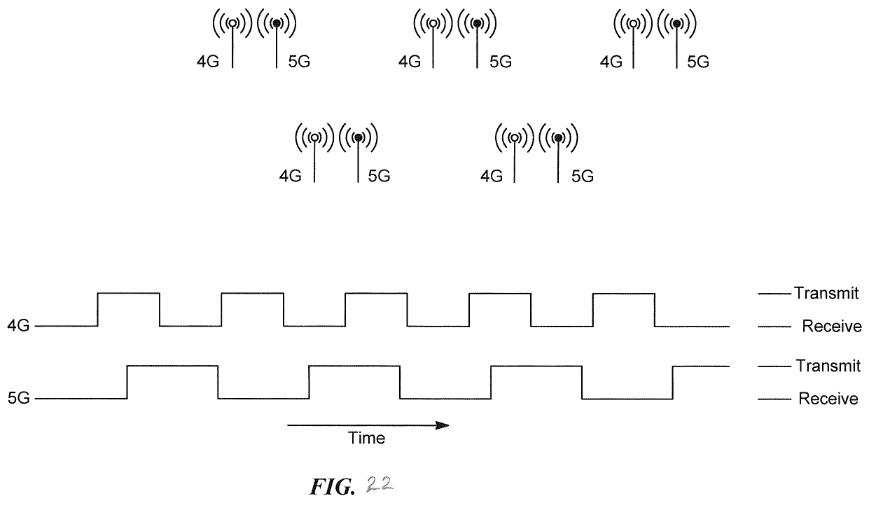

Referring to FIG. 21, to provide more reliable data transmission for 4G data while also supporting data transmission for 5G data, it is desirable that the buffering for the difference sources and their respective transmission are performed in a different manner from one another. In general, the 4G data should be transmitted on a more regular basis, with respect to other data such as 5G, even if the amount of 4G data being transmitted is relatively less than the 5G data being transmitted. One way of achieving this difference in transmission regularity (in comparison to 5G buffer) is to transmit 4G data when a 4G buffer reaches a relatively low threshold level and/or a sufficient time has elapsed since the last time 4G has been transmitted. In this manner, when a relatively large amount of 4G data is being received it is regularly transmitted because its respective buffer is sufficiently full. Also, in this manner, when a sufficient time has elapsed since the last time 4G has been transmitted it guarantees additional 4G data will be transmitted (if any is buffered) (in comparison to 5G elapsed time). In contrast, the 5G data may be buffered and transmitted using all the remaining available bandwidth.

From the perspective of the remote-OLT/OLT 2000, there may be a plurality of ONTs that it is providing 4G and 5G data to and receiving 4G and 5G data from. In this case, the remote-OLT/OLT 2000 preferably regularly transmits 4G data when a 4G buffer reaches a relatively low threshold level for each of the respective ONTs and/or a sufficient time has elapsed since the last time 4G has been transmitted for each of the respective ONTs. In this manner, when a relatively large amount of 4G data is being received it is regularly transmitted because its respective buffer for a particular ONT is sufficiently full. Also, in this manner, when a sufficient time has elapsed since the last time 4G has been transmitted it guarantees additional 4G data will be transmitted for a particular ONT (if any is buffered). In contrast, the 5G data is buffered and transmitted using all the remaining available bandwidth. Also, the bandwidth allocation for each of the ONTs provided by the remote-OLT/OLT 2000 should allocate at least a portion of any queued data for a respective ONT during each frame or a pair of sequential frames. In this manner, the more timely transmission of the 4G data may be performed on an ONT basis.

Referring to FIG. 22, the transmission by 4G cellular antennas operates in a manner that a group of geographically proximate antenna transmits data at the same time wirelessly to other devices and that the group of geographically proximate antenna receives data at the same time wirelessly from other devices. In this manner, the group of antennas are either in a transmission or receiving mode for the 4G cellular data. In this manner, the data across the 4G fronthaul network is primarily unidirectional at any point in time, when the connection is only between the baseband unit and the radio unit. In a similar manner the transmission by 5G cellular antennas operates in a manner that a group of geographically proximate antenna transmits data at the same time wirelessly to other devices and that the group of geographically proximate antenna receives data at the same time wirelessly from other devices. In this manner, the group of antennas are either in a transmission or receiving mode for the 5G cellular data. In this manner, the data across the 5G fronthaul network is primarily unidirectional at any point in time, when the connection is only between the baseband unit and the radio unit. In many implementations, the 4G and 5G cellular antennas are co-located on the same poles or other locations. However, the 4G and 5G cellular antennas are not generally aligned with one another for the transmission and receiving of data. At some times the 4G and 5G are both transmitting data. At some times the 4G and 5G are both receiving data. At some times the 4G is transmitting data and 5G is receiving data. At some times the 5G is transmitting data and 4G is receiving data.

Based upon the temporal nature of the 4G and 5G transmitting and receiving of data, together with the 4G and 5G not being synchronized to one another, there will be variations in the amount of data passed through the backhaul in any particular direction at any particular time that are generally synchronized to the respective 4G and 5G antennas. For example, synchronized with the transmitting of 5G data there will be a substantial amount of 5G data being transmitted upstream. For example, synchronized with the receiving of 5G data there will be a substantial amount of 5G data being transmitted downstream. For example, synchronized with the transmitting of 4G data there will be a substantial amount of 45G data being transmitted upstream. For example, synchronized with the receiving of45G data there will be a substantial amount of 4G data being transmitted downstream. Based upon the synchronized antenna trans-mission/receiving of data together with the 4G and 5G not being synchronized with one another, the remote-OLT/OLT 2000 and/or the ONT 2010 may modify their transmission of data.

For example, when the data for the 5G transmission upstream or downstream tends to decrease, provides an opportunity for the remote-OLT/OLT 2000 and/or the ONT 2010 to increase the data transmission in the upstream or downstream direction for 4G data that is opposite that of the decrease in the 5G transmission.

For example, when the data for the 4G transmission upstream or downstream tends to decrease, provides an opportunity for the remote-OLT/OLT 2000 and/or the ONT 2010 to increase the data transmission in the upstream or downstream direction for 5G data that is opposite that of the decrease in the 4G transmission.

For example, the remote-OLT/OLT 2000 may also expressly grant more bandwidth to each of the respective ONTs that requested for transmission in the upstream direction when there is an increase in the amount of 5G data traffic in the downstream direction. In this manner, each of the ONTs will have sufficient bandwidth to transmit 4G data for which the bandwidth was requested, together with some additional bandwidth to transmit 4G data that arrives at the respective ONT after the request for bandwidth was made. This enables the respective ONTs to further reduce the amount of 4G data that may otherwise be buffered. The express grant for more bandwidth to each of the respective ONTs is not made in a similar manner for the upstream transmission of 5G data traffic.

The techniques described herein may also be used for a mixture of 5G mid-haul and 4G back-haul for the use of passive optical networks.

In another embodiment, the type of PON such as 10G PON (remote-OLT/OLT/ONT) may be used to transmit the 4G data across the backhaul interconnection, while another type of PON such as a 25G PON (remote-OLT/OLT/ONT) may be used to transmit the 5G data across the backhaul interconnection. Both the 10G PON and the 25G PON use separate wavelengths so that the data does not interfere with one another.

In another embodiment, it was determined that particular PON technologies such as GPON, defines a wavelength used to transmit and receive the data. However, the same PON technology also defines wavelength ranges that the transmitter and receiver are immune to, or otherwise needs to sufficiently reject. Accordingly, a first wavelength may be used for the transmission of 4G data across the backhaul interconnection. Accordingly, a second wavelength may be used for the transmission of 5G data across the backhaul interconnection. After further consideration, it was determined that existing 4G based infrastructure for fronthaul and backhaul is often based up Ethernet over optical fiber, and it is preferable that the existing 4G infrastructure remains using Ethernet to ensure backward compatibility. However, the wavelength used for the Ethernet and in particular dense wavelength division multiplexing, should use one of the wavelengths and/or wavelength ranges that a corresponding PON interconnection is immune to or otherwise sufficiently rejects so that the Ethernet based signaling does not interfere with the PON based signaling. A PON based interconnection may be used for 5G for the fronthaul, mid-haul, and/or backhaul to be used on the same interconnection used for 4G based Ethernet data communications. In this manner, the existing 4G system may be expanded to include 5G based signaling, with relatively minor modifications to the system.

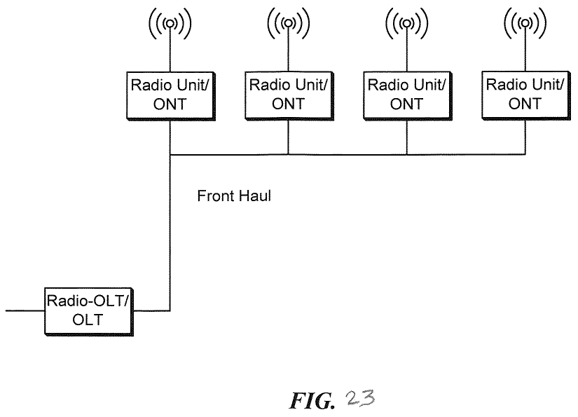

Referring to FIG. 23, a distributed set of radio units together with a respective antenna may be included in a geographic region. A remote-OLT/OLT provides data to each of the ONTs associated with respective ones of the radio units for data to be transmitted. Each of the ONTs associated with a respective one of the radio units also receives data from the respective antenna and provides such data to the remote-OLT/OLT. The remote-OLT may provide data within one or more frames to each of the ONTs and accordingly the radio unit. If the radio unit includes a clock circuit, such as a circuit that determines a synchronized clock based upon signal from the distributed unit/central unit/baseband unit. With the synchronized clock signal, each of the radio units may transmit the data in a synchronized manner with one another. However, in some implementations the ONTs and/or the radio units may not include the ability to determine a synchronized clock, which results in the data being transmitted by the radio units through the respective antenna at different times, albeit relatively close in time to one another.

The PON network has different distances between remote-OLT/OLT and each of the ONTs due its physical location. This results in different times required for signals to reach their respective destinations. For successful time delay data avoidance ranging may be used. Ranging allows adjusting the timing between respective ONTs and the remote-OLT/OLT, giving flexibility in equipment installation. The remote-OLT/OLT sends a specific grant to activate ranging and opens up a window to receive a response from the ONT. The ONT sends a ranging call back to the remote-OLT/OLT, after receiving the grant. The remote-OLT/OLT assigns an equalization delay to each of the ONTs, based on the elapsed time between sending ranging grant and receiving response. In this manner, each of the ONTs may transmit data to the remote-OLT/OLT at a temporally offset delay so that each of the ONTs are temporally aligned with one another, albeit with each of the ONTs have a different transmission delay with respect to the remote-OLT/OLT.

The ranging delay information, which is normally used by the ONTs for transmission to the remote-OLT/OLT, may be used by the remote-OLT/OLT for determination of the offset of such data within one or more frames to for the transmission of data from the remote-OLT/OLT to the ONTs. By way of example, a first radio unit may have an offset of 1, and accordingly may be positioned near the start of a frame. By way of example, a second radio unit may have an offset of 3, and accordingly may be positioned later in the frame at a position such that the data for both the first and second radio unit arrives at the same time at different ONTs. This positioning of data within one or more frames is extended to the remaining radio units that have the same downstream and upstream synchronization. In this manner, the PON signaling technique may be aligned with the cellular signaling technique by offsetting the data within the framing of the PON, based upon the ranging information.

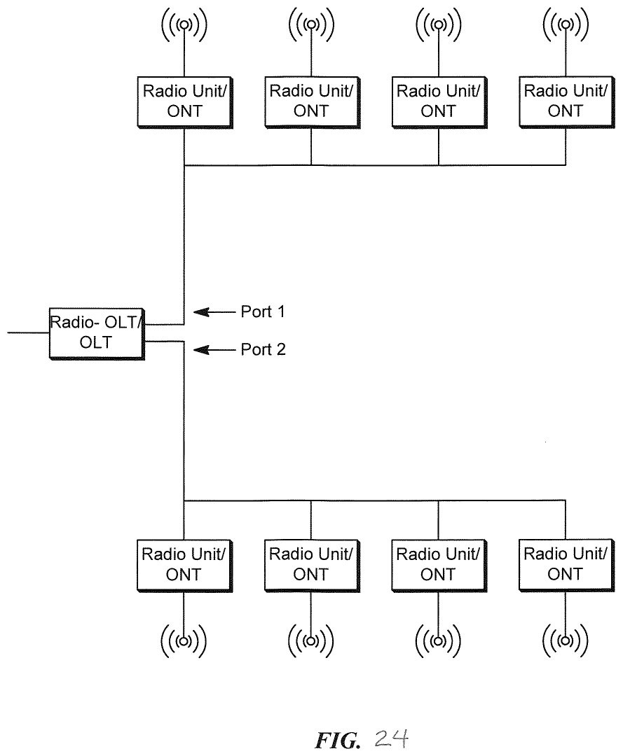

Referring to FIG. 24, in some networks a first set of radio units are interconnected to a first port of the remote-OLT/OLT, where each of the radio units are synchronized with one another for transmitting and receiving data. In some networks a second set of radio units are inter-connected to a second port of the remote-OLT/OLT, where each of the radio units are synchronized with one another for transmitting and receiving data. Further, for geographically dense sets of radio units, the first radio units and the second radio units are preferably synchronized with each other. To achieve this synchronization when the ONTs and radio units do not include the ability to determine a synchronized clock, which results in the data being transmitted by the radio units through the respective antenna at different times, the different ports of the remote-OLT/OLT are synchronized with one another. In this manner, the data being transmitted by each of the ports of the remote-OLT/OLT are effectively synchronized with one another so that the first and second radio units transmit data in a synchronized manner.

For example, for different groups of 4G and/or 5G antennas where each group is not synchronized to the other group, when the transmission upstream or downstream tends to decrease as a result of the synchronized transmitting and receiving of data for a particular group of antennas, provides an opportunity for the remote-OLT/OLT 1000 and/or the ONT 1010 to increase the data transmission in the upstream or downstream direction for data that is opposite that of the decrease in the transmission.

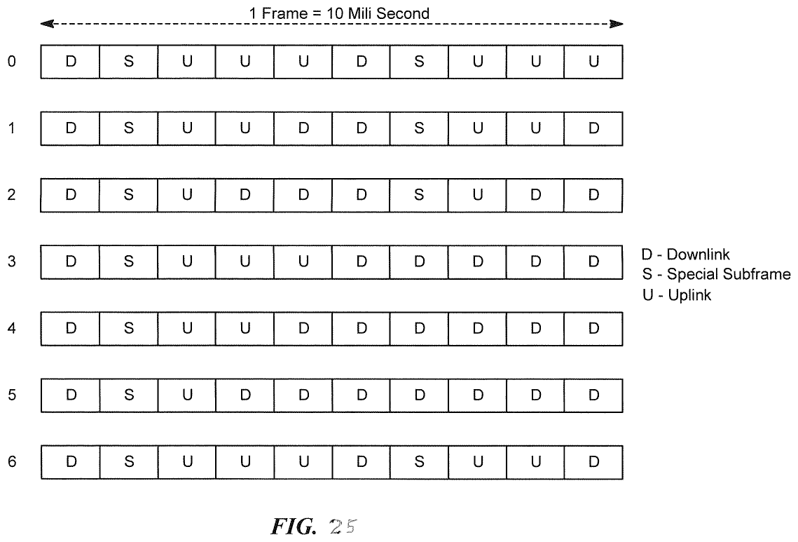

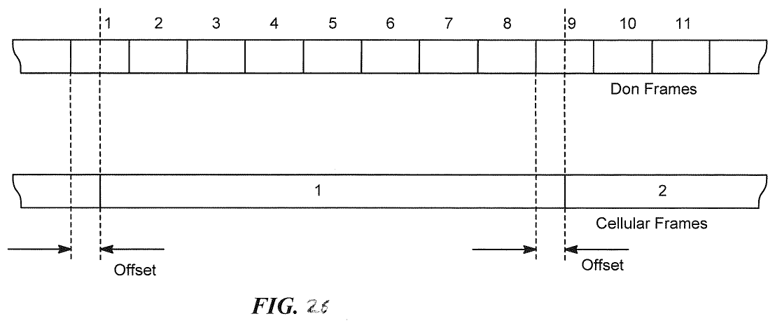

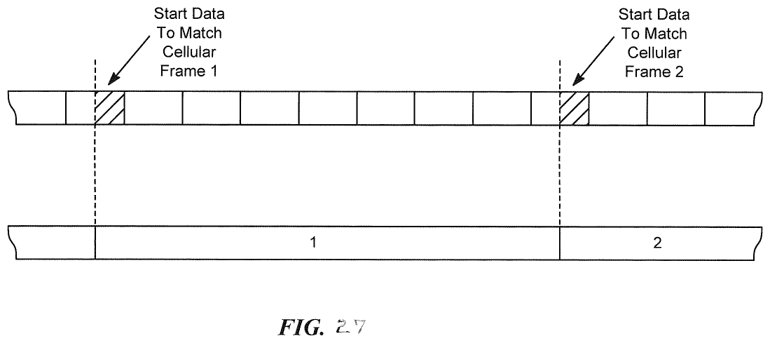

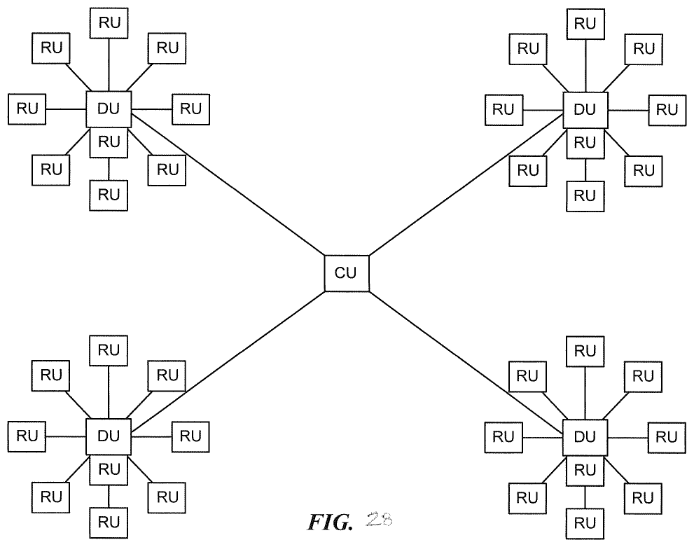

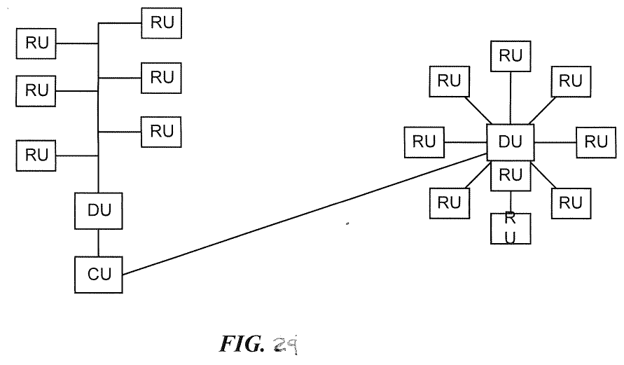

Referring to FIG. 25, a 4G LTE Network typically transmits and receives data as a set of frames, each of which is 10 milli seconds in duration. There is a mixture of 10 subframes within a frame, such as a set of downlink subframes (e.g., 1 milli second in duration) and a set of uplink subframes (e.g., 1 milli second in duration). There may also be a set of one or more special subframes to accommodate some transitions between downlink and uplink. Depending upon the nature of the data transmissions, the system may switch between a set of different downlink and uplink patterns, such as 7 different patterns. Other cellular technologies have similar transmitting and receiving patterns.

Referring to FIG. 26, a typical frame of a passive optical network is substantially shorter than 1 milli second in duration, such as for example, 0.125 milli seconds in duration. For example, approximately 8 passive optical network frames may have approximately the same duration as 1 subframe of the cellular network. With the cellular network tending be predominately either transmitting or receiving data, it is desirable that the timing of the frames of the passive optical network are adjusted to be more closely aligned with the framing of the cellular network. In this manner, the offset between the start of the frames is periodically adjusted by the remote-OLT/OLT to reduce its difference, preferably to be substantially zero. Also, the remote-OLT/OLT may use a boundary clock provided by the DU and/or CU to assist in synchronizing of the timing.

In this manner, the set of PON frames mapping to a cellular frame may predominately be mapped to carry downstream data when the cellular frame is downstream data. In this manner, the set of PON frames mapping to a cellular frame may predominately be mapped to carry upstream data when the cellular frame is upstream data.

The remote-OLT/OLT is typically premised on receiving a set of data, in response to receiving a sufficient amount of data, then providing a “grant map” to the ONTs to indicate the timing of when the ONT can expect to receive the received data, which is then subsequently transmitted to the ONTs in a broadcast manner. As it may be observed, this is a reactionary technique based upon the received data. In a similar manner, the ONT in response to receiving a sufficient amount of data, requests a “grant map” from the remote-OLT/OLT to indicate the timing of when the ONT can transmit the received data, which is then subsequently transmitted to the remote-OLT/OLT. As it may be observed, this is a reactionary technique based upon the received data. The reactionary technique as described tends to delay the transmission of data, in part because of the queuing and the time necessary to construct and distribute the grant maps.

For networks that include the cellular data traffic, which has predominant data traffic in either an upstream or a downstream direction at any particular point in time, and that the upstream or downstream direction may be predicted, it is desirable that the remote-OLT/OLT proactively provide a grant map to the ONTs proximate the start of cellular frame to allocate sufficient bandwidth in the anticipated direction. Also, the remote-OLT/OLT may proactively allocate downstream bandwidth to the ONTs based upon the cellular data traffic. In this manner, the grant map is not provided in response to the data, but rather, at least in part proactively provided based upon the cellular network framing.

The remote-OLT/OLT/ONT may over a series of cellular frames use a learning process to determine the pattern of upstream and downstream subframes. Also, as the pattern of upstream and downstream subframes changes over time, the remote-OLT/OLT/ONT may use the learning process to update the pattern of upstream and downstream subframes. Alternatively, the remote-OLT/OLT/ONT may inspect the data traffic to determine the pattern being used, if desired.

Referring to FIG. 27, as previously described, a typical frame of a passive optical network is substantially shorter than 1 milli second in duration, such as for example, 0.125 milli seconds in duration. For example, approximately 8 passive optical network frames may have approximately the same duration as 1 subframe of the cellular network. With the cellular network tending be predominately either transmitting or receiving data, it is desirable that the timing of the data transmitted by the passive optical network is adjusted to be more closely aligned with the framing of the cellular network. In this manner, the bandwidth map within a PON frame may be offset to align the data transmission with the start of the cellular frame.

In another embodiment, the remote-OLT/OLT may synchronize its clock to the boundary clock of the distribution unit/central unit. In this manner, the frames of the PON and the subframes of the cellular network will be aligned with one another. The predominant proactive grant of data traffic in the downstream or the upstream direction may then be based upon the frames of the PON network.

Referring to FIG. 28, an exemplary cellular network is illustrated with a set of radio units, distributed units, and central units. The symmetrical nature of the cellular network architecture does not lend itself to overlapping of fronthaul, mid-haul, and/or backhaul across the same network interconnection.

Referring to FIG. 29, another exemplary cellular network is illustrated with a set of radio units, distributed units, and central units. The asymmetrical nature of the cellular network architecture lends itself to overlapping of fronthaul, mid-haul, and/or backhaul across the same network interconnection.

Referring to FIG. 30, another exemplary cellular network is illustrated with a set of radio units, distributed units, and central units. The asymmetrical nature of the cellular network architecture lends itself to overlapping of fronthaul, mid-haul, and/or backhaul across the same network interconnection. As it may be observed, the data carried by many particular interconnections will be a mixture of fronthaul, mid-haul, and/or backhaul. Remote-OLTs/OLTs may prioritize fronthaul data traffic, which varies based upon transmitting and receiving by the antennas, provides other times that are suitable for transmitting mid-haul and/or backhaul. Accordingly, in the relatively “dead zones” after the fronthaul transmission in a particular direction, facilitates the additional transmission of mid-haul and/or backhaul in the frames.

The remote-OLT/OLT is capable of differentiating the type of traffic being provided to or being received from a particular ONT, or otherwise another device in the network. This differentiation may be based upon, for example, information regarding the source of the data. This differentiation may be based upon, for example, information from the device providing and/or receiving the data together with what type of data that particular device is designed to handle (e.g., fronthaul, mid-haul, and/or backhaul). This differentiation may be based upon, for example, information provided by the operator of the access network.

Referring to FIG. 31, in many environments, existing 4G infrastructure is being used to send and receive cellular communications, inclusive of power sources, towers, and right of ways for backhaul communications. When providing 5G (or otherwise) services, it is desirable to make use of existing infrastructure, such as power sources, towers, and right of ways. The 5G services may be provided in a manner that minimizes its impact on the existing 4G services, while also preferably making use of the same backhaul interconnection. The existing 4G infrastructure may include a tower 3300, with an antenna 3310, a 4G radio unit 3320, a 4G fronthaul interconnection (typically running CPRI with multiple gigabits of data per second) 3330, a 4G baseband unit 3340, and a 4G backhaul interconnection (typically running a few megabits of data per second) 3350.

Referring to FIG. 32, a modified structure includes existing 4G infrastructure together with adding 5G infrastructure. A portion of the existing 4G infrastructure may include a tower 3400, an antenna 3410, a 4G radio unit 3420, a 4G fronthaul interconnection (typically running CPRI with multiple gigabits of data per second) 3430, and a 4G baseband unit 3440. A 5G infrastructure may include the tower 3400, with an antenna 3450, a 5G radio unit 3460, a 5G fronthaul interconnection (typically running eCPRI with a substantial number of gigabits of data per second) 3470. The 5G fronthaul interconnection 3470 is interconnected to an ONT 3480, so that 5G fronthaul data may be provided to the 5G radio unit 3460 and received from the 5G radio unit 3460. The 4G baseband unit 3440 may be interconnected with a 4G backhaul interconnection (typically running a few megabits of data per second) 3490. As it may be observed, the ONT 3480 provides data selectively to either the 5G radio unit 3460 or the 4G baseband unit 3440 which is then in turn provided to the 4G radio unit 3420. Accordingly, the ONT 3480 provides data services to both a fronthaul interconnection and a backhaul interconnection.

The ONT 3480 has an optical fiber link 3494 to a corresponding remote-OLT/OLT 3496 which carries a combination of 4G backhaul and 5G fronthaul. The remote-OLT/OLT 3496 may interconnected to a distributed unit 3498 for 5G data and/or a router 3488 for 4G data.

The ONT 3480 is preferable capable of separating the 4G backhaul data from the 5G fronthaul data, where the 5G fronthaul data has a substantially higher data rate. The ONT 3480 preferably includes a small form pluggable interface for the 4G backhaul 3490 interconnection. One technique for the ONT 3480 to distinguish 4G data from 5G data is to include tags on the 4G and/or the 5G data. By way of example, the 5G data may be transmitted without being tagged as being 5G data, while the 4G data is encapsulated, tagged, transmitted, and unencapsulated to ensure it goes through unchanged.

The remote-OLT/OLT is typically premised on receiving a set of data, in response to receiving a sufficient amount of data, then providing a “grant map” to the ONTs to indicate the timing of when the ONT can expect to receive the received data, which is then subsequently transmitted to the ONTs in a broadcast manner. As it may be observed, this is a reactionary technique based upon the received data. In a similar manner, the ONT in response to receiving a sufficient amount of data, requests a “grant map” from the remote-OLT/OLT to indicate the timing of when the ONT can transmit the received data, which is then subsequently transmitted to the remote-OLT/OLT. As it may be observed, this is a reactionary technique based upon the received data. The reactionary technique as described tends to delay the transmission of data, in part because of the queuing and the time necessary to construct and distribute the grant maps.

For networks that include the cellular data traffic, which has predominant data traffic in either an upstream or a downstream direction at any particular point in time, and that the upstream or downstream direction may be predicted, it is desirable that the remote-OLT/OLT proactively provide a grant map to the ONTs proximate the start of cellular frame to allocate sufficient bandwidth in the anticipated direction. Also, the remote-OLT/OLT may proactively allocate downstream bandwidth to the ONTs based upon the cellular data traffic. In this manner, the grant map is not provided in response to the data, but rather, at least in part proactively provided based upon the cellular network.

The remote-OLT/OLT/ONT may over a series of cellular frames use a learning process to determine the pattern of upstream and downstream subframes. Also, as the pattern of upstream and downstream subframes changes over time, the remote-OLT/OLT/ONT may use the learning process to update the pattern of upstream and downstream subframes. Alternatively, the remote-OLT/OLT/ONT may inspect the data traffic to determine the pattern being used, if desired.

The asymmetrical nature of the cellular network architecture lends itself to overlapping of fronthaul, mid-haul, and/or backhaul across the same network interconnection. As it may be observed, the data carried by many particular interconnections will be a mixture of fronthaul, mid-haul, and/or backhaul. Remote-OLTs/OLTs/ONTs may prioritize fronthaul data traffic, which varies based upon transmitting and receiving by the antennas, provides other times that are suitable for transmitting mid-haul and/or backhaul. Accordingly, in the relatively “dead zones” after the fronthaul transmission for 5G in a particular direction, facilitates the additional transmission of mid-haul and/or backhaul in the frames for 4G.

This pre-allocation for the transmission of data may be based upon information from the cellular network indicating a subsequent need for data bandwidth, which may include an indication of the time where the allocation is desirable. By using this pre-allocation information from the cellular networking, the remote-OLT/OLT/ONTs do not need to be reactionary to the actual receipt of data to be transmitted.

Referring to FIG. 33, during the initial deployment of a cellular network for a new area, such as fixed wireless access for a residential neighborhood, there tends to be relatively limited initial usage of the cellular network. A set of radio units 4300 are each interconnected with a respective antenna 4310 and interconnected with a respective optical network terminal 4320 to receive data from the respective radio units. Each of the optical network terminals 4320 may be interconnected to the other optical network terminals 4320 and a remote-OLT/OLT 4330 with a tap and/or splitter (or otherwise) 4340. With such an access network, a first wavelength within the optical fiber is used for downstream communication which is provided in a manner akin to a “broadcast” and a second wavelength is used for upstream communication which is temporally shared among the various ONTs based upon a “grant map” provided by the remote-OLT/OLT 4330. By way of example, the radio units may be designed to service a limited number of residential customers, where the radio units are installed on a series of telephone poles along a neighborhood.

As residential customers signup for the cellular network the usage of selected radio units tends to increase and thus the overall usage of the access network further increases over time. One or more of the radio units may be providing a substantial amount of the data being transmitted across the passive optical network, which with ever increasing data rates, may tend to degrade the network for other customers or otherwise exceed the capacity of the passive optical network. Rather than set up particular radio units with a passive optical network based upon using a different technology or otherwise different wavelengths, it is desirable to selectively modify particular ONTs to include an Ethernet based interconnection rather than a passive optical network-based interconnection based upon PON protocols.

Referring to FIG. 34, a modified cellular network may include a selected ONT 4400 (or multiple ONTs) being modified to provide an Ethernet based signaling on a pair of wavelengths (e.g., one wavelength for downstream and one wavelength for upstream) that are different than other wavelengths being used in the respectively portions of the cellular network. It is noted that the taps and/or splitters (or otherwise) 4340 typically include a sufficiently wide frequency range to support a range of wavelengths that may be used.

The modified cellular network may further be modified to include a wavelength division multiplexer 4410 (inclusive of a dense wavelength division multiplexer). The wavelength division multiplexer 4410 is a fiber optic device that enables the use of multiple light wavelengths to send data over the same transmission medium. The remote-OLT/OLT 4330 may be interconnected to the x-haul of the cellular network, such as a distributed unit 4420 and a central unit 4430 in the case of a 5G cellular network. The central unit 4430 may provide Ethernet based data 4440 to the wavelength division multiplexer 4410 and receive data therefrom. The wavelengths provided by the central unit 4430 and/or wavelength divisional multiplexer 4410 correspond with the wavelengths of the ONT 4400. In this manner, there is effectively a point-to-point interconnection made between the ONT 4400 and the central unit 4430 for the transmission of data.

Referring to FIG. 35, it is sometimes difficult to replace an entire ONT that is installed on a pole or at some other location to change the output from a PON based protocol to an Ethernet based protocol due to the need to disconnect the interconnection to the corresponding radio unit and remove the ONT from its location. The movement of the physical ONT together with its disconnection from the radio unit tends to increase the likelihood of installation concerns, especially for devices that have been installed for a substantial length of time and exposed to the environment. Rather than replacement of the ONT, the ONT preferably includes a detachably engageable module that includes the optical components therein. The detachably engageable module may be in the form of a small form-factor pluggable which is a compact network interface module. The SFP interface includes a media-specific transceiver, such as a PON transceiver or an Ethernet transceiver, at a selected wavelength. Accordingly, for the ONT 4400, a small form-factor pluggable module 4500 that includes a PON based transceiver may be detached from the ONT 4400 (including disconnecting its optical fiber). A small form-factor pluggable module 4510 may be engaged in the ONT 4400 (including connecting its optical fiber). In this manner, the transceiver of the ONT 4400 is modified from a PON based protocol to an Ethernet based protocol, together with changing the wavelengths used for communication by the ONT 4400.

The ONT 4400 includes a first set of firmware that generates PON based protocol framing and at PON based data rates that may be provided to the small form-factor pluggable module 4500 that includes a PON based transceiver. The ONT 4400 includes a second set of firmware (or otherwise a FPGA, software, dedicated hardware, ASICS, etc.) that generates Ethernet based protocol framing and at Ethernet based data rates that may be provided to the small form-factor pluggable module 4510 that includes an Ethernet based transceiver. The ONT 4400 may automatically provide the corresponding PON based protocol or the Ethernet based protocol based upon which of the small form-factor pluggable modules are inserted. As it may be observed, the network includes two wavelengths for the PON based communications, and two wavelengths for each of the ONTs that are modified from PON based communications to Ethernet based communications. The ONT may automatically switch protocols, or otherwise the operator may switch a setting within the ONT. In either case, the firmware for providing PON and Ethernet is present in the ONT at the same time.

By way of example, the process for performing an upgrade may be as follows to reduce service interruption. The wavelength division multiplexer is added to the network and the central unit is interconnected to the wavelength division multiplexer to provide the Ethernet based wavelengths of interest though the same optical fiber as the PON based protocol, together with suitable wavelength filtering. The ONT which is to be changed from PON based small form-factor pluggable to Ethernet based small form-factor pluggable involves unplugging the optical fiber from the small form-factor pluggable, changing the small form-factor PON pluggable to small form-factor Ethernet pluggable, and plug the optical fiber to the Ethernet small form-factor pluggable.

In addition, if there is a mixture of 4G data traffic over PON and 5G data traffic over PON, the remote-OLT/OLT and/or the ONT may modify their transmission characteristics such that the 5G data traffic is prioritized over the 4G data traffic. In addition, this may make use of the “dead zones” as a result of the substantially unidirectional nature of the temporal antenna transmission and reception.

The bandwidth management typically involves two principal issues, namely, bandwidth negotiation and bandwidth allocation. Bandwidth negotiation is related to exchanging information between the OLT and each ONT in order for each ONT to report its bandwidth demand to the OLT and for the OLT to send its bandwidth allocation decision to each ONT. See, IEEE 802.3ah, incorporated by reference herein in its entirety. For example, for EPON the bandwidth negotiation includes two 64-bytes MAC control messages: REPORT and GATE. The REPORT message is generated by each ONT to report its queue status to the OLT. The OLT allocates bandwidth for each ONT based on the queue status information contained in the received REPORT messages, and uses the GATE message to deliver its bandwidth allocation decision to each ONT.

The bandwidth allocation allocates bandwidth (or a timeslot) for each ONT that the OLT needs to perform based on the bandwidth requests from each ONT as well as some allocation policy and/or service level agreement. Typically, the bandwidth allocation is based upon either static bandwidth allocation (SBA) or dynamic bandwidth allocation (DBA). The DBA dynamically allocates a variable timeslot to each ONT based on the instantaneous bandwidth demand of the ONTs. In one embodiment, the OLT may dynamically allocate bandwidth for each ONT based upon polling to flexibly arbitrate the transmission of multiple ONTs.

For example, the dynamic bandwidth allocation may employ a resource negotiation process to facilitate queue report and bandwidth allocation. The OLT polls ONTs and grants timeslots to each ONU in a round-robin fashion. The timeslot granted to an ONT is determined by the queue status reported from that ONT. Therefore, the OLT is able to know the dynamic traffic load of each ONT and allocate the upstream bandwidth in accordance with the bandwidth demand of each ONT. Moreover, it also employs the service level agreements of end users to upper bound the allocated bandwidth to each ONT.

For example, the dynamic bandwidth allocation may be based upon an estimation to at-tempt to reduce the queue length of each ONT and thus the average packet delay by estimating the packets arrived at an ONT during a waiting time and incorporating the estimation in the grant to the ONT. In such an estimation technique, a control gain is used to adjust the estimation based on the difference between the departed and arrived packets in the previous transmission cycle.

For example, the dynamic bandwidth allocation may use an interleaved polling with adaptive cycle time with grant estimation, together with sharing the upstream channel among multiple ONTs. The amount of packets arriving at an ONT between two consecutive pollings is estimated based on the self-similarity characteristic of network traffic, and the OLT decides the granted transmission size for the ONT based on the estimated packet amount as well as the amount requested in the previous polling cycle. By estimating the amount of new arriving packets and granting an additional window size, the grant size to the ONT will be close to the real buffer occupancy at the time when the ONT is polled.

For example, the dynamic bandwidth allocation may use a bandwidth guaranteed polling where the ONTs are divided into two groups: bandwidth guaranteed and bandwidth non-guaranteed. The OLT performs bandwidth allocation through using polling tables. The first polling table divides a fixed-length polling cycle into a number of bandwidth units and each ONT is allocated a certain number of such bandwidth units. The number of bandwidth units allocated to an ONT is determined by the bandwidth demand of that ONT, which is given by its service level agreement. A bandwidth guaranteed ONT with more than one entry in the poling table has its entries spread through the table. This can reduce the average queuing delay because the ONT is polled more frequently.

For example, a fair sharing with dual service level agreements may employ dual service level agreements to manage the fairness for both subscribers and service providers. The primary service level agreement specifies those services whose minimum requirements must be guaranteed with a high priority. The secondary service level agreement describes the service requirements with a lower priority. This technique may first allocate timeslots to those services with the primary service level agreement to guarantee their upstream transmissions. After the services with the primary service level agreement are guaranteed, the next round is to accommodate the secondary service level agreement services. If the bandwidth is not sufficient to accommodate the secondary service level agreement services, a max-min policy is adopted to allocate the bandwidth with fairness.

As cell phones have become nearly ubiquitous over the last few years, and smartphones have become the primary type of cell phone used in many countries, the data traffic generated by smartphones has increased dramatically. A Radio Access Network (RAN) provides access to a core network for a mobile terminal, such as a smartphone. RANs have progressed through several different generations of technology, and are sometimes referred to by a so-called “generation number,” such as 3G, or 4G, or 5G, networks. An example 2G RAN is the GSM (Global System for Mobile Communications) Radio Access Network (GRAN), example 3G RANs include the GSM EDGE Radio Access Network (GERAN), and the Universal Mobile Telecommunications System (UMTS). An example 4G network is the Long-Term Evolution Advanced (LTE-A) which is also known as the Evolved Universal Terrestrial Radio Access Network (E-UTRAN) and may also be referred to simply as “LTE” herein. Each RAN communicates with mobile terminals using radio frequency communication protocols defined by the RAN at frequencies supported by the RAN and licensed by a particular communications company, or carrier. The frequencies are modulated using a variety of techniques, depending on the RAN, to carry digital information that can be used for voice transmission and/or data transfer.

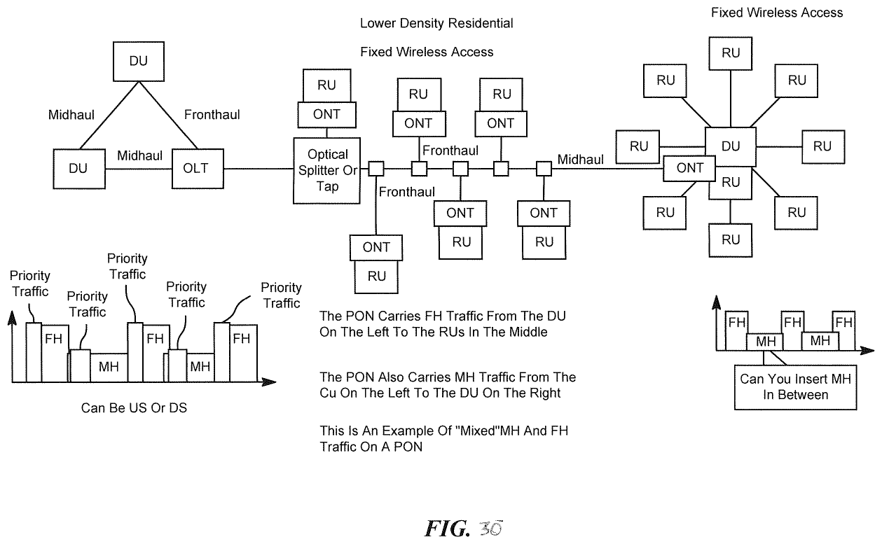

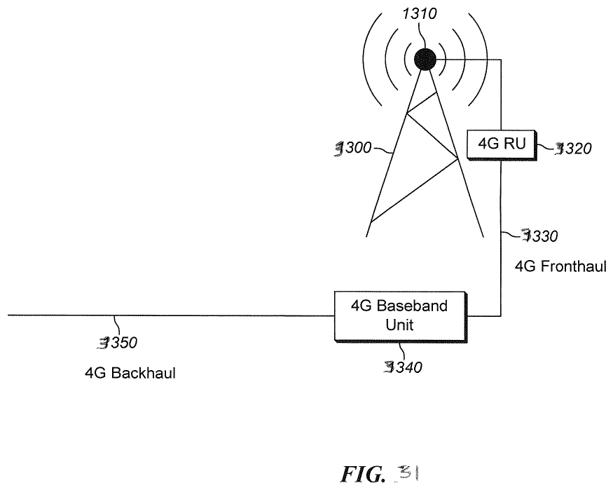

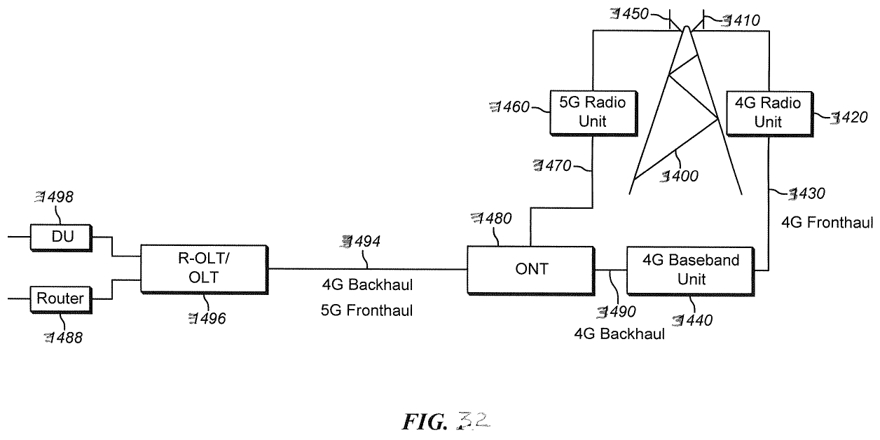

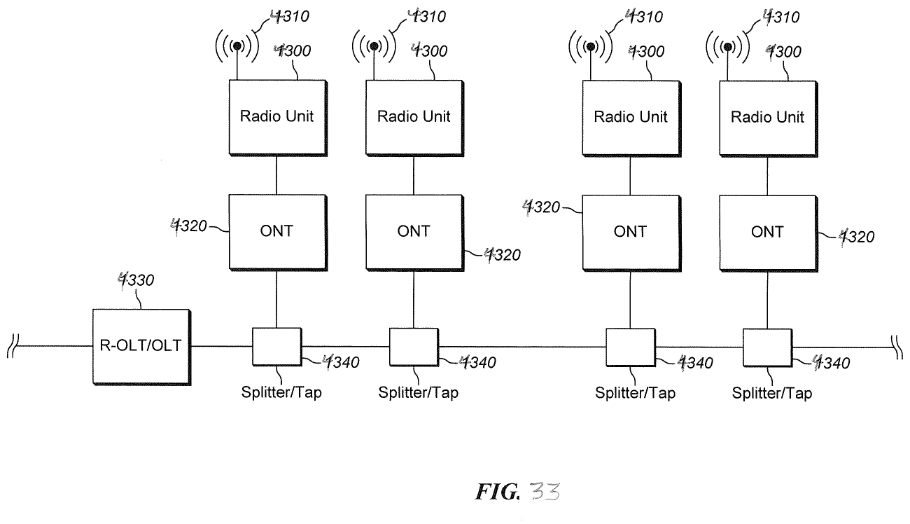

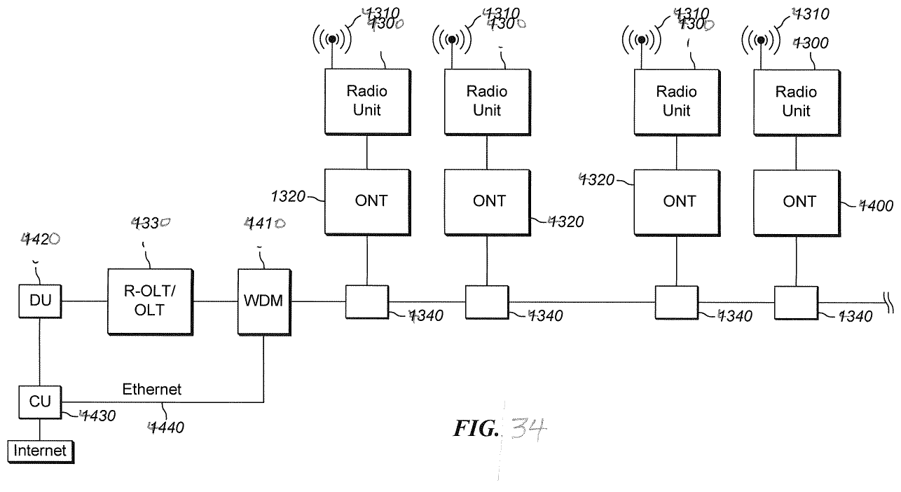

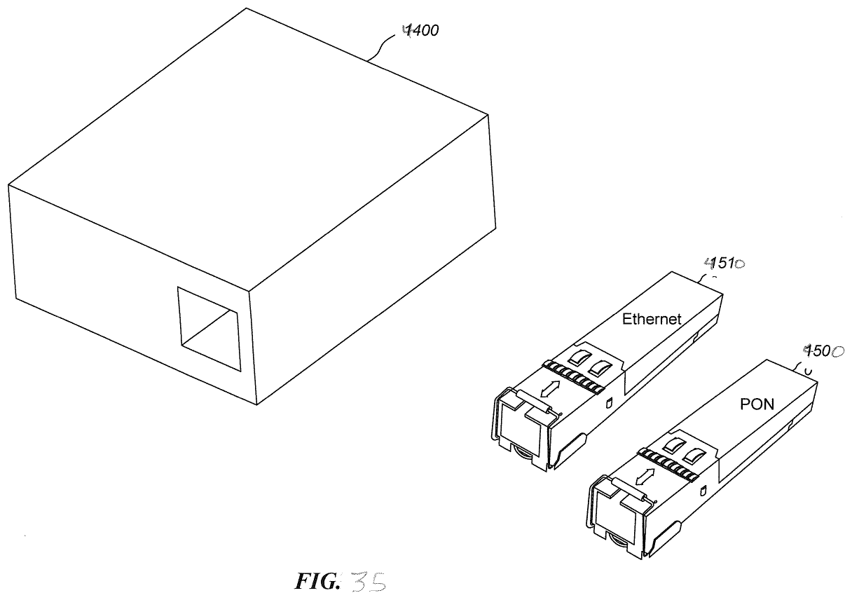

Referring to FIG. 36, a Baseband Unit (BBU) is a portion of a base station of a radio access network (RAN) that implements most, or all, of the OSI layer 2 functionality of the RAN and may include functionality of higher OSI network layers. The BBU may also be referred to as a virtual radio access network (vRAN), and the terms may be used interchangeably. In some embodiments, the BBU may include portions of the OSI layer 1 functionality of the RAN and a data connection to a remote radio unit (RRU).

The Remote Radio Unit (RRU), which can also be referred to as a remote radio head (RRH), is a portion of a base station of a RAN that includes a connection to couple to an antenna and transmitter and/or receiver circuitry, but does not include full OSI layer 2 functionality of the RAN, such as medium access control (MAC) functionality. A RRU also includes some or all of the OSI layer 1 functionality of the RAN and a data connection to a baseband unit (BBU).

A fronthaul link, or fronthaul connection, is a data connection used by a BBU and/or RRU to communicate with each other. Any sort of data communication mechanism can be used, depending on the embodiment, but in at least some embodiments, a network is used that is com-patible with a standard published or maintained by The Institute of Electrical and Electronic Engineers (IEEE) 802 working groups, such as a version of the IEEE 802.3 standard (i.e. Ethernet), a version of the IEEE 802.11 standard (i.e. Wi-Fi), or a version of IEEE 802.16 (i.e. WiMAX). The BBU allocates bandwidth among the different remote radio units and/or the cellular based communications for user equipment. If a network having a non-deterministic protocol, such as an internet protocol (IP) network, is used, an adaptive link protocol can be used by the BBU and/or RRU for communication over that link. Links which do not pass a clock from one end to the other, such as asynchronous links, are also considered to be non-deterministic. In other embodiments, the fronthaul link may be a dedicated fiber-grade link using common public radio interface (CPRI) or other deterministic or non-deterministic protocol.

User Equipment (UE) refers to a device in wireless communication with the base station of the RAN. It may also be referred to as a mobile terminal, mobile device, wireless terminal, or a wireless device and the terms may be used interchangeably, even though some UE may not be mobile or may not be completely wireless (e.g. may have a wired power connection). Examples of UE include smartphones, tablets, mobile Wi-Fi hotspots, remote data collection units (e.g. weather stations), and connected automobiles.

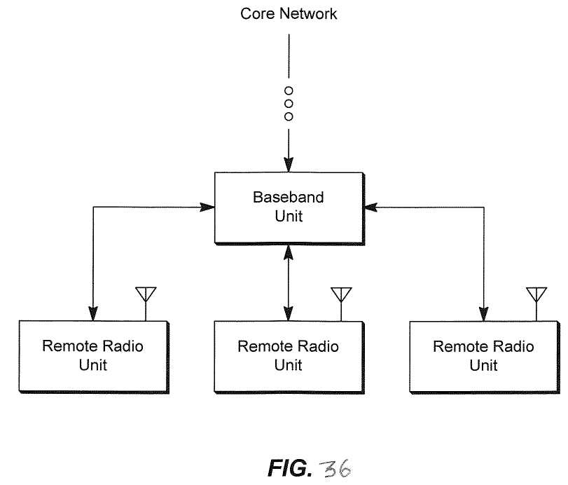

Referring to FIG. 37, a fronthaul connection used by the BBU and/or RRU may include a passive optical network, such that the baseband unit including the receiving and transmitting components of an optical network terminal (ONT). In this manner, the BBU and/or RRU provides a fronthaul connection using a passive optical network based protocol to an optical line terminal, which in turn is interconnected to the core network.

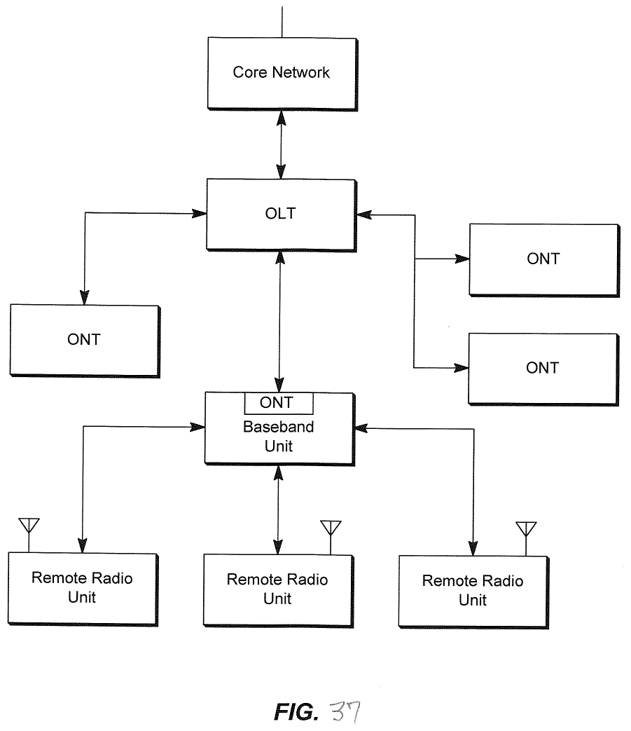

Referring to FIG. 38, while interfacing the baseband unit and/or the remote radio unit with a passive optical network protocol is desirable for some implementations, the low latency requirements of the cellular transmissions traditionally would not consider such passive optical network-based protocol to be suitable. To provide a lower latency based passive optical network-based protocol interconnection between the BBU and/or RRU and the OLT it is desirable to include some type of coordination between the BBU and/or RRU and the OLT. By way of example, the BBU and/or RRU may send a message to the OLT that indicates that a substantial amount of bandwidth has been granted for a particular user equipment and that the dynamic bandwidth allocation provided by the OLT may pre-allocate bandwidth to the ONT for the data that is anticipated to be provided. The pre-allocation is determined by the OLT apart from traditional requests by the ONT for bandwidth. The BBU and/or RRU in combination with its associated ONT provides data to the OLT as a result of the UE of the potential for pre-allocated bandwidth.

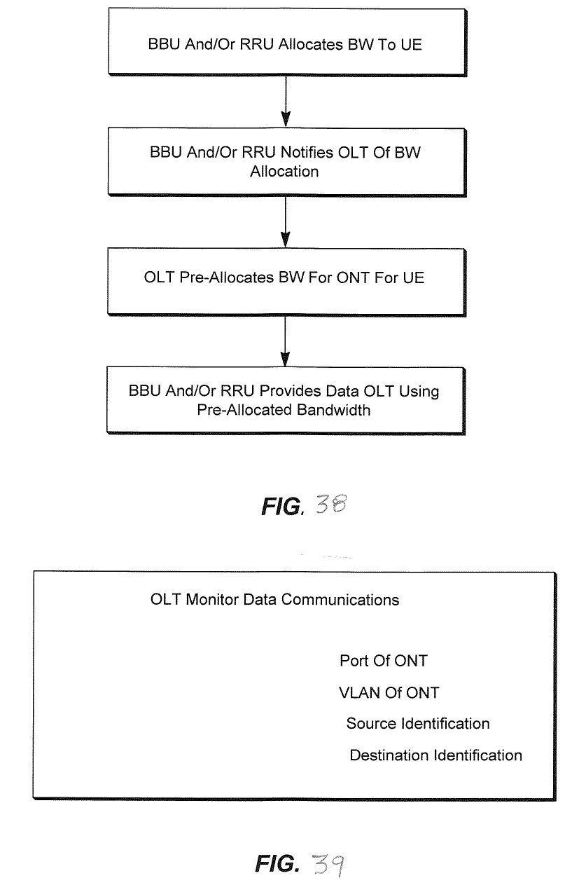

Referring to FIG. 39, in another embodiment the OLT may monitor the data transmissions for the particular ONT associated with the UE, with the expectation that the UE tends to be burst type data communications or otherwise relatively consistent type data communications for streaming audio and/or video content. The OLT may monitor the data communications based upon a port of the ONT associated with the BBU and/or RRU. The OLT may monitor the data communications based upon a virtual local area network associated with the ONT associated with the BBU and/or RRU. The OLT may monitor the data communications based upon a combination of a source identification and/or a destination identification, inclusive of a FlowID of IEEE 1914.3 incorporated by reference herein, of the data from the ONT associated with the BBU and/or RRU.

The ONT includes buffers therein which tend to fill up when a substantial amount of data is being provided at a rate slower than the current allocation of bandwidth provided by the OLT in its dynamic bandwidth allocation. The pre-allocation of bandwidth provided by the OLT based upon the BBU and/or RRU with the associated ONT may further be based upon the amount of data currently buffered it the ONTs buffers. If a substantial amount of data is currently buffered by the ONT then the pre-allocation may include a greater bandwidth than would otherwise been pre-allocated. If an insubstantial amount of data is currently buffered by the ONT then the pre-allocation may include a lesser bandwidth than would otherwise been pre-allocated. Also, the pre-allocation of additional bandwidth over time, while data is being provided from the BBU and/or RRU, may further be based upon the amount of data that is currently buffered by the ONT, by increasing and decreasing the pre-allocated bandwidth that would have otherwise been pre-allocated. Accordingly, as the buffer tends to fill up the bandwidth may be pre-allocated to increase the available bandwidth. Accordingly, as the buffer tends to empty the bandwidth may be pre-allocated to decrease the available bandwidth. The further management of the amount of data within the buffer(s) of the ONT, especially for the cellular based user equipment, may significantly reduce the latency of signals.

In addition, the dynamic bandwidth allocation may further be based upon the service level agreement of each of the particular user equipment devices. For example, a high service level agreement may result in a greater amount of pre-allocated bandwidth than would have otherwise been pre-allocated. For example, a low service level agreement may result in a lesser amount of pre-allocated bandwidth than would have otherwise been pre-allocated.

In addition, the dynamic bandwidth allocation may further be based upon the nature of the data transmission. For example, streaming video content may result in a greater amount of pre-allocated bandwidth than would have otherwise been pre-allocated. For example, web browsing may result in a lesser amount of pre-allocated bandwidth than would have otherwise been pre-allocated.

As mobile phones (inclusive of those that send and receive telephone calls and/or data communications) have become ubiquitous, and smart phones (e.g., iPhone from Apple) have become the primary type of mobile phones used, the data traffic generated by smart phones has increased dramatically. This increase in data traffic has grown much faster than that of the available radio spectrum for such data traffic. Radio spectrum is a fixed resource, so making any additional frequency bands available for smart phones, or other mobile terminals, comes at the expense of other uses. This makes efficient use of the existing spectrum important. Accordingly, network deployment and maintenance are expensive, lengthy, and error-prone processes.

A Radio Access Network (RAN) provides access to a core network for a mobile terminal, such as a smart phone. RANs have progressed through several different generations of technology, and are sometimes referred to by a so-called “generation number,” such as 3G, or 4G, or 5G, or 6G networks. For example, 2G RAN is the GSM (Global System for Mobile Communications) Radio Access Network (GRAN). For example, 3G RANs include the GSM EDGE Radio Access Network (GERAN), and the Universal Mobile Telecommunications System (UMTS). For example, 4G network is the Long-Term Evolution Advanced (LTE-A) which is also known as the Evolved Universal Terrestrial Radio Access Network (E-UTRAN) and may also be referred to simply as “LTE” herein. Each RAN communicates with mobile terminals using radio frequency communication protocols defined by the RAN at frequencies supported by the RAN and licensed by a particular communications company, or carrier. The frequencies are modulated using a variety of techniques, depending on the RAN, to carry digital information that can be used for voice transmission and/or data transfer.

Each RAN can define its own software structure, but many generally conform to the 7-layer Open Systems Interconnection (OSI) model. The seven layers include a lowest layer, layer 1, which is commonly referred to as the physical layer or PHY, which describes the transmission and reception of raw bit streams over a physical medium. The next layer, layer 2, is known as the data link layer, but often is referred to by the name of a protocol that resides at that layer, such as the medium access protocol (MAC), or point-to-point protocol (PPP), which provide for transmission of data frames between two nodes connected by a physical layer. The third layer, known as the network layer, manages a multi-node network and handles such issues as addressing, to send packets of data between nodes. The internet protocol (IP) is a commonly used network layer protocol. The next layer, layer 4, is known as the transport layer. Common transport protocols include the transmission control protocol (TCP) and the user datagram protocol (UDP). Transport protocols manage transmission of data segments between nodes of the network. Layer 5, the session layer, manages communication sessions, layer 6, the presentation layer, translates data between a networking service and an application, and the top layer, layer 7 or the application layer, provides high-level application programming interfaces (APIs) for network related services.

More details of an E-UTRAN are provided as an example. The specifications for E-UTRAN are developed and published by the 3rd Generation Partnership Project (3GPP). The specifications related to E-UTRAN are known as the 36 series specifications and are available for download from the 3GPP website at http://www.3gpp.org/DynaReport/36-series.htm. Several of the specifications include information helpful in understanding this disclosure, including: “LTE; Evolved Universal Terrestrial Radio Access (E-UTRA); LTE physical layer; General description,” 3GPP TS 36.201 version 12.1.0 Release 12, 2015-02; “LTE; Evolved Universal Terrestrial Radio Access (E-UTRA); Physical channels and modulation,” 3GPP TS 36.211 version 12.4.0 Release 12, 2015-02; “LTE; Evolved Universal Terrestrial Radio Access (E-UTRA) and Evolved Universal Terrestrial Radio Access Network (E-UTRAN); Overall description; Stage 2,” 3GPP TS 36.300 version 12.4.0 Release 12, 2015-02; and “LTE; Evolved Universal Terrestrial Radio Access (E-UTRA); Medium Access Control (MAC) protocol specification,” 3GPP TS 36.321 version 12.4.0 Release 12, 2015-02; all of which are incorporated by reference herein.

In an E-UTRAN, a base station is known as an enhanced node B (eNB) and a mobile terminal is known as user equipment (UE). An eNB can manage one or more cells, also called sectors, and is responsible for transmission and reception of wireless signals as well as interfacing with the core network, known as evolved packet core (EPC). It provides connectivity, that is, reliable data transfer (whenever possible), and control paths to the UEs in its coverage area. An eNB communicates with a UE using a pair of carrier frequencies, one for uplink (UL) and one for downlink (DL), if using Frequency Division Duplex (FDD), or using a single carrier frequency for both UL and DL if using Time Division Duplex (TDD). The DL uses Orthogonal Frequency Division Multiple Access (OFDMA) modulation of the carrier, and the UL uses Single-Carrier Frequency Division Multiple Access (SC-FDMA), which is also known as Lin-early Precoded OFDMA (LP-OFDMA). While the two modulation schemes are different, they share many similar qualities, and the term “OFDM” may generally be used herein to describe either scheme.

In a traditional implementation, eNBs are separate logical entities, connected to the same core network via the Si interface, which can be conveyed over a wired or wireless backhaul connection. An optional X2 interface may be used to directly connect neighbor eNBs. During a call, a UE may be handed over to neighbor eNBs, depending on radio conditions and traffic load. Handovers imply, among other things, a transfer of “context” of the UE being handed over, from a source eNB to a destination eNB. Such transfer may occur via the Si interface or via the X2 interface, if available. The functions of the eNB can be broadly classified as radio frequency (RF) functions that deal with radio frequency signals and baseband (BB) operations that deal with digital data.

An eNB implements several functions which together can be classified baseband (BB) operations. The baseband operations include the physical-layer (PHY) functions, medium access control (MAC) layer functions, radio link control (RLC) layer functions, packet data converge protocol (PDCP) layer functions, and/or radio resource control (RRC) layer functions.

Physical-layer (PHY) functions include, among others, transmission of downlink physical channels, such as physical downlink control channel (PDCCH), physical downlink shared channel (PDSCH), and cell-specific reference signal (CRS). The PHY layer functions also include reception of uplink physical layer channels, such as physical uplink shared channel (PUSCH), physical uplink control channel (PUCCH), physical random-access channel (PRACH), and sounding reference signal (SRS). The PHY layer also handles synchronization, measurements of radio conditions, and other miscellaneous functions.

Medium access control (MAC) layer functions include scheduling, mapping of transport channels to logical channels, maintenance of uplink timing alignment, hybrid automatic repeat request (HARD) operation, and discontinuous reception (DRX). Radio link control (RLC) layer functions include concatenation, segmentation, reassembly, reordering, and error correction (through ARQ). Packet data convergence protocol (PDCP) layer functions include in-sequence delivery of data units, header compression, elimination of duplicates, ciphering and deciphering, and integrity protection and verification. Radio resource control (RRC) layer functions include broadcast of system information, connection control, mobility, and measurement configuration and control.

Traditionally all eNB functions are carried out by specialized hardware devices, dedicated telecommunications equipment, data centers, and the like. In such traditional systems, the entire eNB is located in one location, allowing the eNB to be managed as a single unit. In another implementation, one or more eNBs are managed by the same hardware device or co-located devices and the transmission and reception antennas corresponding to the eNBs are distributed in a potentially large region. In such implementation, groups of co-located antennas may be denoted as remote radio heads (RRHs), and a special interface connects the processing device with the RRHs it manages. An RRH can also be referred to as a remote radio unit (RRU), and the terms are used interchangeably herein.

In one implementation, which may be referred to as a distributed RAN or a Cloud-RAN, an RRH is targeted to have a smaller form factor, reduced power consumption, and lower operating expenses. To meet this goal, the RRH implements a minimum set of functions. In such implementations, the RRH may only include radio frequency (RF) functions such as amplification, filtering, up and down frequency conversion, digital to analog and analog to digital con-versions, and the like, and baseband processing is still performed by dedicated equipment, which may not be co-located with the RRH.

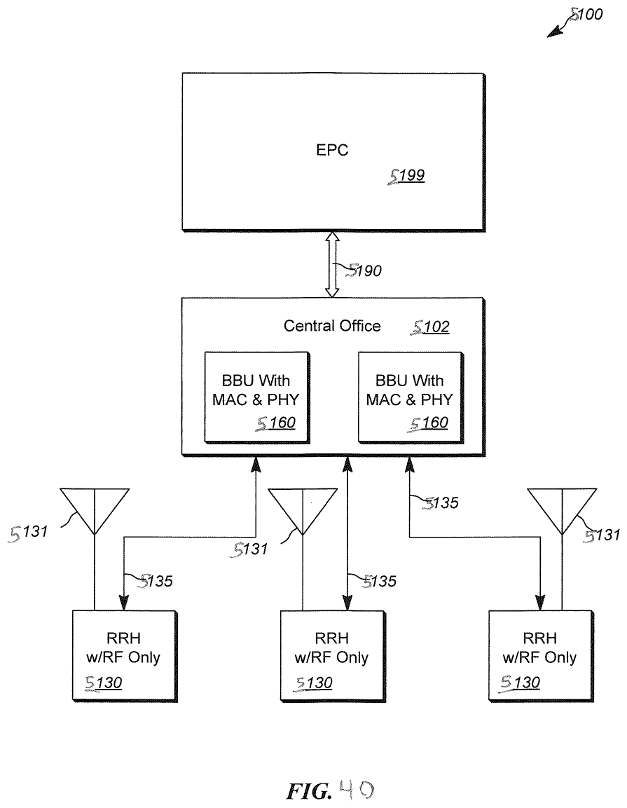

Referring to FIG. 40, a block diagram of a traditional distributed RAN 5100 is illustrated. The RAN 5100 includes a central office 5102 with one or more baseband units (BBUs) 5160 that include all of the functionality for the PHY layer and the MAC layer of the RAN protocol. The RAN 5100 also includes multiple RRUs 5130 that include RF functionality and are each coupled to one or more antennas 5131 to communicate with UE devices, such as smartphones. The interface between a BBU 5160 and an RRH 5130, is referred to as a fronthaul link 5135. A traditional fronthaul link 5135, can utilize a wired, optical, or radio frequency physical link, but the traditional fronthaul link is synchronous, low-jitter, and usually point-to-point. In some cases, the fronthaul link 5135 uses a proprietary protocol, but in many implementations, a standardized protocol, such as the Common Public Radio Interface (CPRI) or the Open Base Station Architecture Initiative (OBSAI), is used. A central office 5102 may host multiple BBUs 5160, which in turn may control multiple RRUs 5130. The BBUs 5160 of the central office 5102 are coupled to the core network, or EPC 5199, by a backhaul link 5190 that may utilize standard networking technology and is more tolerant of latency and jitter issues than the fronthaul link 5135.

One issue with a distributed RAN 5100 architecture is synchronization. Each RRU 5130 is synchronized with the other RRUs 5130 so that they create a coordinated environment for the UEs. If a synchronous fronthaul link 5135 is used, the clocks in the RRHs 5130 and the BBUs 5160 are kept synchronized through the synchronous nature of the fronthaul link. But even in such systems, synchronizing the RRHs 5130 and BBUs 5160 shown in FIG. 40 with other BBUs and RRHs of the RAN 5100 may use additional resources. In some cases, a carrier-grade global-positioning-system (GPS) receiver is included in each BBU or RRH to extract a highly accurate clock signal and each device is then locked to the that GPS clock so that they stay synchronized. In addition, if a non-deterministic link is used for the fronthaul, there is no clock to use to keep the BBUs and RRHs synchronized, which is one reason why deterministic, synchronous links, such as CPRI, have traditionally been used for the fronthaul link in distributed RANs.

A Baseband Unit (BBU) is a portion of a base station of a radio access network (RAN) that implements most, or all, of the OSI layer 2 functionality of the RAN and may include functionality of higher OSI network layers. The BBU may also be referred to as a virtual radio access network (vRAN), and the terms may be used interchangeably. In some embodiments, the BBU may include portions of the OSI layer 1 functionality of the RAN and a data connection to a remote radio unit (RRU).

A Remote Radio Unit (RRU), which can also be referred to as a remote radio head (RRH), is a portion of a base station of a RAN that includes a connection to couple to an antenna and transmitter and/or receiver circuitry, but does not include full OSI layer 2 functionality of the RAN, such as medium access control (MAC) functionality. An RRU also includes some or all of the OSI layer 1 functionality of the RAN and a data connection to a baseband unit (BBU).

A fronthaul link, or fronthaul connection, is the data connection used by a BBU and RRU to communicate with each other. Any sort of data communication mechanism can be used, depending on the embodiment, but in at least some embodiments, a network is used that is com-patible with a standard published or maintained by The Institute of Electrical and Electronic Engineers (IEEE) 802 working groups, such as a version of the IEEE 802.3 standard (i.e. Ethernet), a version of the IEEE 802.11 standard (i.e. Wi-Fi), or a version of IEEE 802.16 (i.e., WiMAX). If a network having a non-deterministic protocol, such as an internet protocol (IP) network, is used, an adaptive link protocol can be used by the BBU and RRU for communication over that link. Links which do not pass a clock from one end to the other, such as asynchronous links, are also considered to be non-deterministic.

User Equipment (UE) refers to a device in wireless communication with the base station of the RAN. It may also be referred to as a mobile terminal, mobile device, wireless terminal, or a wireless device and the terms may be used interchangeably, even though some UE may not be mobile or may not be completely wireless (e.g. may have a wired power connection). Examples of UE include smartphones, tablets, mobile Wi-Fi hotspots, remote data collection units (e.g. weather stations), and connected automobiles.

A distributed radio access network (RAN) uses one or more baseband units (BBUs) coupled to one or more remote radio units (RRUs) over a fronthaul link. This system may be referred to as using Radio-as-a-Service, (RaaS) technology or a RaaS system. The BBUs can be based on proprietary hardware or can be implemented using software on a computer server, although dedicated hardware acceleration added to the server may be used in some embodiments. The RRUs are typically built using custom hardware and include, or are coupled to, a radio frequency (RF) receiver, transmitter, or transceiver.

RaaS technology enables deployment and maintenance of RAN systems, including 4G networks, and clears the path to 5G networks and 6G networks. RRUs are simple and relatively inexpensive plug-and-play devices that allow RAN connectivity to be positioned wherever it is needed, and BBUs can be instantiated on commodity servers to implement the RAN software stack without any dedicated hardware in many cases. With such a virtual implementation of the radio stack, network updates and upgrades can be handled as software patches using well-established techniques for updating software. Thus, a RaaS architecture makes it straightforward to adopt advanced features such as LTE-U (LTE in unlicensed spectrum) or even 5G or 6G.

A BBU may run in the cloud, for example as a software instance running in a data center, using an adaptive fronthaul protocol over a standard IP-based network to communicate with one or more RRUs. The adaptive fronthaul protocol may be referred to as RaaS Fronthaul over IP (RaaS-FIP). RaaS-FIP may be used for the exchange of datagrams between a BBU and an RRU. Many different RAN architectures can be supported by a RaaS architecture including, but not limited to, LTE and LTE-A. In another implementation, at least one BBU may be connected to at least one RRU through a link that does not rely on IP and RaaS-FIP, such as through a dedicated link employing the common public radio interface (CPRI) protocol. Each BBU implements at least some portion of the networking stack of the RAN, including layer 2 and in some cases portions of layer 1. Higher level layers, may also be included in some embodiments of the BBU.

RaaS can virtualize the RAN stack by replacing dedicated, expensive, and bulky base stations with software running on general purpose x86 or ARM CPUs communicating with small, easily deployed RRUs. BBUs can be deployed in many different ways. In some cases a BBU can be a dedicated hardware unit, which may be based on commodity hardware, or as software installed on a standard computer, such as a rack-mounted server. A BBU may be positioned in traditional central office type installations. In such situations, an IP-based fronthaul link using RaaS-FIP may be used for communication between the BBU and RRU, but in some cases a non-IP-based fronthaul link, such as with a deterministic protocol like CPRI, may be used with dedicated hardware for the communications link included in the dedicated BBU hardware unit. In some cases, BBUs may be mobile, such as using BBUs instantiated on racks of commodity server mounted in a truck. But in many cases, BBUs are instantiated on servers based in data centers, and a standard IP-based network is used for communications with the RRUs. The data centers and servers may be owned by the carrier, or they may be owned by a third party that leases the computers to the carrier. In some cases, BBUs can be instantiated using a public computing cloud service such as those offered by Google Compute Engine (GCE) compute services or Amazon Web Services (AWS) compute services.

Positioning RRUs where they are needed allows a carrier to respond to changing customer demands. In a traditional RAN architecture, significant planning and manual configuration needs to take place to deploy a new set of base stations which are bulky and expensive. In a RaaS system, RRUs can be easily positioned where they are need and BBUs dynamically instantiated in a remote data center to support the RRUs as they are positioned. In fact, the RRUs can even be mobile, located on ground-based or aerial vehicles, and the RaaS system can dynamically respond to, or even control, the movement of the mobile RRUs to meet the ever-changing requirements of the mobile terminals in use. BBUs can also be mobile and dynamically associated with RRUs automatically. This can be useful in situations where mobile device usage may peak, such as at concerts and sporting events, events occurring in areas with little to no permanent RAN coverage, and emergency situations, such as responding to a natural disaster, where much of the existing infrastructure may be non-operational. The RaaS system provides the benefits of virtualization, including resource pooling and dynamic allocation of resources when and where it is needed. In addition, all of this can be done with little to no advance planning due to the automatic dynamic allocation of the requested resources.

Cellular base stations have synchronization requirements to support reliable communications. In a typical traditional RAN implementation, all RRUs controlled by the same BBU are kept time-synchronized and frequency-synchronized by relying on the fronthaul signalling, which forces the use of synchronous fronthaul protocols such as CPRI. The more general case is the fronthaul connecting at least one BBU to at least one RRU may be non-deterministic links using an asynchronous network and/or using an asynchronous network protocol, such as IP-based fronthaul links over Ethernet or Wi-Fi networks. Some of the methods may also apply to deployments in which at least one RRU acts as a stand-alone base station where the RRU implements all layers of the RAN protocol stack and communicates directly with the core network without passing through a BBU.

Other RAN standards, including LTE, suggest or mandate that all time and frequency references used on one base station (also known as eNB in LTE) are derived from the same clock (referred to as “master clock” hereafter) via simple operations such as digital clock multiplications or divisions. Hence, when the master clock frequency is synchronized within the desired accuracy, all other frequency values, such as sampling rate, carrier frequency, and the like, also are within the desired accuracy. Standard-compliant base stations are required to meet very stringent constraints in terms of master clock accuracy. For example, the error cannot exceed 50 ppb (parts per billion) for LTE macro cells, whereas indoor small cells are given less strict requirements, which range up to 250 ppb for Release 8 enhanced Home Node B's (eHNBs).

While base stations that meet the master clock frequency requirements are standard-compliant, in some deployments it is desirable that the additional synchronization requirement of “timing alignment” to synchronize various protocol-related functions is met among different base stations, especially among units that may generate radio interference on each other. The desired accuracy for timing alignment may depend on the specific deployment. For example, in LTE, a timing alignment between eNBs with an error that doesn't exceed the OFDM cyclic prefix typically may allow a user equipment (UE) receiving radio signals from the interfering eNBs to cope with interference better with respect to the case of eNBs with greater timing alignment error (or no alignment at all). In another LTE example, support of advanced features such as coordinated multipoint (CoMP) and enhanced inter-carrier interference coordination (eICIC) may rely on tighter time-alignment constraints. For example microsecond-level timing alignment, or even better, is desired among eNBs in CoMP configuration.

These synchronization considerations, described above with reference to base stations, hold similarly for RRUs. In particular, RRUs controlled by the same BBU are typically expected to be tightly time aligned (e.g., microsecond-level alignment, or better, in LTE), whereas RRUs that don't generate radio interference on each other and are not controlled by the same BBU may be aligned less strictly, or not be aligned at all.

Synchronization refers to master clock frequency and timing alignment synchronization, within the desired accuracy, of a single target radio unit, or a single base station, to a reference clock. Traditionally, this has been achieved by deploying a carrier-grade Global Positioning System (GPS) receiver on the target base station which results in it being locked to the atomic-grade clock of the GPS system. In scenarios with a BBU/RRU split, the BBU is traditionally GPS-synchronized, whereas the RRU is not. In such systems, to guarantee that the synchronization at the RRU side is within the desired accuracy, the link between BBU and RRU has traditionally been a dedicated synchronous link based on CPRI or similar protocols which enables locking of the RRU clock to the BBU clock. While functional for some installations, this option is not always feasible, such as when GPS coverage is poor or absent, and not always cost effective as dedicated synchronous links may be much more expensive than general-purpose links over packet-switched networks such as those based on the Internet Protocol (IP), over links such as Ethernet of Wi-Fi. Various synchronization methods and mechanisms are described herein which function in RaaS systems using a non-deterministic fronthaul link for communication between a BBU and an RRU. The same mechanisms can also be used with a synchronous fronthaul link.

In embodiments, an RRU may be equipped with hardware or software able to receive a certain reference signal, or more reference signals, but may be missing at least a portion of the hardware or software needed for extraction of synchronization metrics, so that the RRU may not be able to autonomously implement synchronization tasks. In this embodiment, another device, such as a BBU in communication with the RRU, may be equipped with the hardware or software needed to complete the extraction of synchronization metrics, and may help the RRU in the synchronization process. For example, an RRU may be able to tune to a certain carrier frequency used by an LTE eNB for downlink and record the signal received on it, but may not be able to extract any synchronization metric from the downlink LTE signal. The RRU may send samples of the received signal (or a portion thereof), possibly compressed or otherwise preprocessed, to the associated BBU via a fronthaul link, and the BBU can then extract synchronization metrics. In embodiments with synchronous fronthaul protocols, such as CPRI, the BBU can then use the metrics to correct the fronthaul clock and, consequently, the RRU clock that is locked to the clock of the fronthaul link. In embodiments with non-deterministic fronthaul protocols, such as those using RaaS-FIP, the BBU may send synchronization information to the RRU for correction of its clock. As an example, the BBU may send a command, encapsulated in RaaS-FIP, instructing the RRU to increase its master clock frequency by 30 ppb and to delay its time reference by 2 ns. The choice of what signals to use and at what time to use them may be managed by the BBU or some other device upstream from the BBU.

Such embodiments may allow for support of different synchronization signals, even allowing support for new synchronization signals over time, and can reduce the cost of the RRUs which may dominate the overall system cost. For these reasons, RaaS embodiments based on very simple and inexpensive RRUs driven by powerful and programmable BBUs, may allow for lower cost RAN deployments with greater capabilities.

For reception of a radio signal to use as a reference for synchronization, an RRU may be instructed to tune to a frequency different from the one that it tunes to for main-functionality reception. As a non-limiting example of this, an LTE RRU may tune to a certain LTE uplink frequency for main-functionality reception and may tune to a different frequency, such as the GPS 1575.42 MHz frequency, for synchronization-assisting reception. The RRU may be equipped with different receive chains, which may operate at the same time or at different times, with different chains tuned to different frequencies. In the previous example, the LTE RRU might be equipped with two receive chains, one for main-functionality reception of LTE uplink and one for synchronization-assisting GPS reception, possibly active at the same time. In some embodiments, a receive chain may be dynamically programmable so that at different times the receive chain may tune to different radio frequencies, either selected from a discrete set of frequencies or from a frequency range, and possibly use different sampling rates, either selected from a discrete set of sample rates or from a range of sample rates. For example, the LTE RRU used in the example above might be equipped with a single programmable receive chain which is used at different times for main-functionality reception of LTE uplink, for synchronization-assisting GPS reception, or for synchronization-assisting reception of a downlink cellular signal. The implementation in which at least one of the receive chains is programmable may be used for embodiments in which flexibility and configurability is an important added value, as well as embodiments in which multiple receive chains are not viable or cost effective. In some embodiments, at least one of the receive chains may be able to capture a wideband spectrum that includes at least two radio signals of interest for the RRU. Thus an LTE RRU may be equipped with a single wideband receive chain able to perform, at the same time, both main-functionality reception of LTE uplink and synchronization-assisting reception of a downlink cellular signal using a single receive chain.

In certain implementations, synchronization-assisting reception may prevent the RRU from performing main-functionality reception at a certain time. A cellular RRU may be equipped with a single receive chain unable to receive main-functionality cellular uplink signals and synchronization-assisting GPS signals at the same time, for example. In this case, the logic driving the RRU's configuration and scheduling may account for that information. For example, an LTE BBU may decide not to schedule for uplink traffic any UE near a certain RRU while the RRU is unable to perform LTE uplink reception because the RRU is performing, is about to perform, or has recently performed, synchronization-assisting reception. In another example, scheduling metrics may influence the decision on when to perform synchronization-assisting reception. An LTE RRU may be configured to perform synchronization-assisting reception, for example, only at times in which no main-functionality LTE uplink traffic is scheduled, such as during “empty” uplink subframes, and, for TDD LTE, downlink subframes, DwPTS and guard periods.

An RRU may use a synchronization-assisting radio-frequency signal whose radio spectrum overlaps, entirely or partially, with the radio spectrum of the signal being transmitted by the RRU. In this case, special care may be needed because of the well-known ‘deafening’ effect that may make it problematic to receive a signal in the scenario. Received signal enhancement techniques, possibly based on self-interference cancellation may be employed, such as those described by Mayank Jain et al. in “Practical, Real-time, Full Duplex Wireless” published in the Proceedings of the 17th Annual International Conference on Mobile Computing and Networking (Mobicom 2011) which is incorporated by reference herein.

Alternatively, or in addition, the logic driving the scheduling decisions and the selection of what synchronization-assisting radio-frequency signals to use, and when to use them, may aim at limiting the occurrences of deafening, or at not allowing any occurrence at all. For example, an LTE RRU may be configured to perform reception on a frequency spectrum that overlaps with the spectrum of the LTE downlink signal transmitted by the RRU only at times in which no downlink transmission is scheduled, such as during “empty” downlink OFDM symbols, and, for TDD LTE, uplink sub-frames, UpPTS and guard periods. In another example, an LTE BBU may determine not to schedule any LTE downlink signal for a certain RRU while the RRU is performing reception on a frequency spectrum that overlaps with the spectrum of the LTE downlink signal.

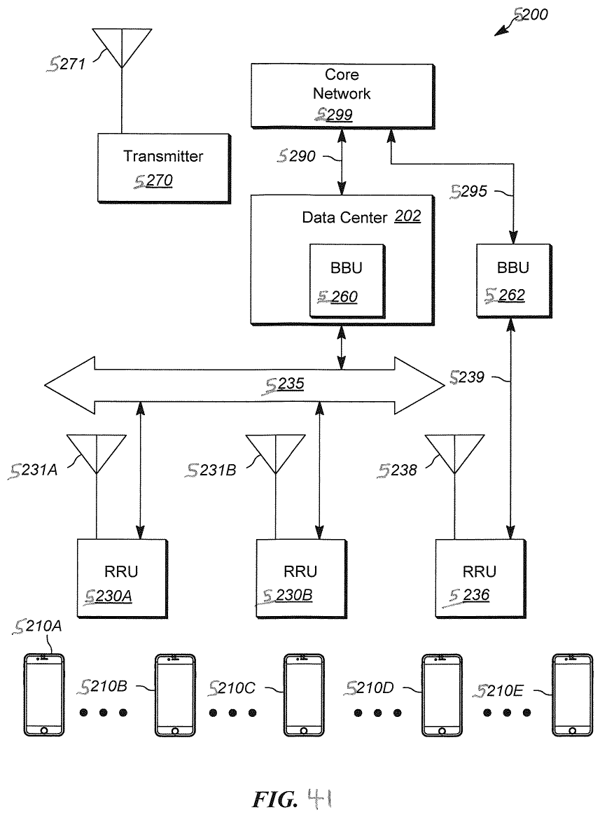

FIG. 41 is a block diagram of an embodiment of a distributed radio access network (RAN) 5200 using RaaS technology. The RAN 5200 represents a radio frequency communication system to facilitate communication between wireless terminals 5210A-E and a core network 5299. The system 5200 includes a first remote radio unit (RRU) 5230A and a baseband unit (BBU) 5260 coupled by a fronthaul link 5235. The RAN 5200 can be any type of RAN, but in at least some embodiments, the RAN 5200 is an Evolved Universal Terrestrial Radio Access Network (E-UTRAN), and the core network 5299 includes an Evolved Packet Core (EPC). The techniques are likewise applicable to other types of radio access networks, including legacy networks such as Universal Mobile Telecommunications System (UMTS), other contemporary networks such as Worldwide Interoperability for Microwave Access (WiMAX).

The RAN 5200 includes a first remote radio unit (RRU) 5230A coupled to an antenna 5231A to communicate with a wireless terminal 5210A using radio frequency signals. Depending on the system, any number of RRUs can be included, such as a second RRU 5230B coupled to a second antenna 5231B, and a third RRU 5236 coupled to third antenna 5238. The multiple RRUs 5230A-B, 5236 can be geographically distributed and/or there can be multiple RRUs 5230A-B, 5236 in a single location. A single RRU 5230A can be coupled to any number of antennas, although many installations couple two antennas to each RRU 5230A-B, 5236. Each RRU 5230A-B, 5236 includes electronic circuitry to perform at least a first portion of a first-level protocol of the RAN 5200 for communicating between a wireless terminal 5210A-E and the core network 5299.

The RAN 5200 also includes a baseband unit (BBU) 5260 coupled to the core network 5299. Embodiments may include any number of BBUs. The BBU 5260 may be implemented using software running on a computer server in data center 5202. The server may be one of multiple servers situated in a data center 5202 which provides power, cooling, network connectivity, and management, to the servers. In some cases the data center 5202 and its servers may be owned by a carrier that operates the RAN 5200, but in other cases, the data center 5202 and its servers may be owned by a third party provider that leases specific equipment or resources to the operator of the RAN 5200.

In embodiments the BBU 5260 performs at least a second level protocol of the radio access network (RAN) and may perform a portion of a first-level protocol of the RAN 5200. The RRUs 5230A-B communicate data of the communication with the at least one wireless terminal 5210A-E over the fronthaul link 5235 with the BBU 5260. The BBU 5260, in this embodiment, communicates over the fronthaul link 5235 with one or more RRUs 5230A-B using a non-deterministic protocol where a latency, an arbitration, a bandwidth, a jitter, a packet order, a packet delivery, or some other characteristic of the communication link, cannot be determined with certainty in advance. One example of a non-deterministic fronthaul link is an Ethernet network. In at least some embodiments, the first-level protocol of the RAN 5200 comprises an Evolved Universal Terrestrial Radio Access (E-UTRA) physical-layer (PHY) protocol, and the second-level protocol comprises an E-UTRA medium access control (MAC) protocol. In many embodiments, the non-deterministic protocol uses a packet-based protocol with non-guaranteed in-order packet delivery and/or non-guaranteed packet delivery, such as an internet protocol (IP). Furthermore, some of additional BBUs may be remotely located in the “cloud”, that is, data and control transport channels may be established between a remote BBU and an RRU, and those channels may be routed over multiple different physical media, and may be processed by multiple intermediate network nodes, such as routers, switches, and the like.

Embodiments described herein may utilize an adaptive fronthaul protocol for communication between the RRU and the BBU. An adaptive fronthaul protocol provides mechanisms for the BBU and/or RRU to react to changes in the environment, such as the changes in the fronthaul, the radio signal, the loads of the mobile terminals coupled to the RRUs, or other characteristics of the system, to provide a graceful adaptation to the changes instead of losing the connection between the BBU and RRU if the new conditions cannot support the previous parameters of the connection.

The RAN 5200 may alternatively, or additionally, include a stand-alone BBU 5262 implemented either as software running on a general-purpose computer or as purpose-built system. The BBU 5262 communicates with RRU 5236 by a synchronous fronthaul link 5239 and with the core network 5299 using a backhaul link 5295. In some embodiments, the synchronous fronthaul link 5239 may utilize protocols of a common public radio interface (CPRI). As in the other BBUs and RRUs of the RAN 5200, the BBU 5262 performs at least a second-level protocol of the RAN 5200 and the RRU 5236 performs at least a portion of a first-level protocol of the RAN 5200. The RRU 5236 also communicates with the at least one wireless terminal 5210A-E using radio-frequency signals.

In some embodiments, the RAN 5200 may include a transmitter 5270 to transmit a synchronization-assisting radio-frequency signal. Depending on the embodiment, the transmitter 5270 may be a stand-alone device or the transmitter 5270 may be communicably coupled to, and controlled by, the BBU 5260. The transmitter 5270 may also be referred to as a beacon and the synchronization-assisting radio-frequency signal may in some embodiments be based on a very accurate clock in the transmitter 5270, such as a clock derived from a high-accuracy GPS receiver located in the transmitter 5270.

The RRUs 5230A-B, 236 may be built with any combination of electronic circuitry and software, depending on the embodiment. In some embodiments, at least one RRU 5230A, but in other embodiments, every RRU 5203A-B, 5236, includes a radio-frequency receiver to receive a synchronization-assisting radio-frequency signal. The synchronization-assisting radio-frequency signal can be any radio-frequency signal suitable for extracting time-base information, including, but not limited to, GPS signals, broadcast television signals, cellular downlink signals transmitted by base stations (e.g., LTE eNBs), cellular uplink signals transmitted by UEs, ‘beacon’ signals transmitted by devices meant to synchronize nearby radios (such as transmitter 5270), time radio signals such as WWVB, and the like. In some embodiments, the radio-frequency receiver is a programmable radio which can be used to receive a wide variety of frequencies and modulation schemes. Depending on the embodiment, the radio-frequency receiver may be used for both a RAN 5200 uplink receiver and a synchronization-assisting radio-frequency signal receiver. In other embodiments, the receivers for the uplink and the synchronization-assisting radio-frequency signal may be separate receivers.

Once it has received the synchronization-assisting radio-frequency signal, the RRU 5230A can process the received signal to derive information about the signal, such as digital samples, compressed digital samples, or otherwise processed digital samples. The information derived from the synchronization-assisting radio-frequency signal is then sent over the fronthaul link 5235 to the BBU 5260. The RRU 5230A then receives synchronization instructions over the fronthaul link from the BBU 5260 and adjusts a local clock based on the synchronization instructions.

The BBU 5260 is configured to receive the information derived from the synchronization-assisting radio-frequency signal over the fronthaul link 5235 and process the information derived from a synchronization-assisting radio-frequency signal to determine synchronization instructions. The BBU 5260 then sends the synchronization instructions to the RRU 5230A over the fronthaul link 5235. In some embodiments, the BBU 5260 may also send instructions to the RRU 5230A controlling some aspect of receiving the synchronization-assisting radio-frequency signal, such as what frequency to tune to, what time period to capture, or some other aspect of receiving the signal or deriving the information from the signal.

In some embodiments, a second RRU 5230B is included which is also communicably coupled to the BBU 5260 and configured to receive the synchronization-assisting radio-frequency signal. In such embodiments, the electronic circuitry of the BBU 5260 may be further configured to receive and process second information from the second RRU 5230B derived from the synchronization-assisting radio-frequency signal, and determine the synchronization instructions based on both the information received from the RRU 5230A and the second information received from the second RRU 5230B.

While the RAN 5200 includes a separate transmitter 5270 to transmit the synchronization-assisting radio-frequency signal, other embodiments may transmit the synchronization-assisting radio-frequency signal from an RRU or BBU. So as a non-limiting example, the RRU 5230B, which is communicably coupled to the BBU 5260, may be configured to transmit the synchronization-assisting radio-frequency signal. In some embodiments the RRU 5230B may include a GPS receiver and the synchronization-assisting radio-frequency signal may be derived from a received GPS signal. In some embodiments, the BBU 5260 is further configured to send instructions to the second RRU 5230B controlling at least one aspect of the synchronization-assisting radio-frequency signal, such as instructions controlling when the synchronization-assisting radio-frequency signal is transmitted, what data is transmitted, and/or a carrier frequency of the synchronization-assisting radio-frequency signal.

Synchronization-assisting devices such as the transmitter 5270, which also may be called a beacon, are devices that are deployed with the goal of aiding the synchronization process. A beacon may be a dedicated device with a primary, or only, function of transmitting an accurate synchronization-assisting radio signal. Alternatively, beacon functionalities may be implemented on a device that is intended to perform at least one function not related to the beacon functionalities, such as a device whose main functionality is acting as an LTE eNB but is also equipped with a beacon chain for transmission of a separate synchronization-assisting radio-frequency signal. In some embodiments, transmission of beacon signals may not necessarily require a dedicated transmit chain. For example, in a RaaS LTE deployment, beacon RRUs may transmit synchronization-assisting radio-frequency signals in the portions of the spectrum transmitted by the RRUs in which no LTE downlink signal is transmitted (the downlink guard bands), or at times in which no downlink signal is being transmitted, such as during “empty” downlink OFDM symbols, and, for TDD LTE, uplink sub-frames, UpPTS and guard periods. This can be done as long as such transmissions are standard-compliant so that no spectrum emission requirements are violated.

A device that implements beacon functionalities may be provided with very accurate clock synchronization by using dedicated hardware or other techniques, including those described herein. For example, a beacon device may be placed in a location with good GPS coverage and be equipped with a carrier-grade GPS receiver, or may be placed in a location with good LTE coverage and be able to achieve accurate clock synchronization by processing LTE downlink signals with at least one of the techniques described herein.

A beacon may transmit at least one signal based on waveforms that allow accurate timing alignment (e.g., waveforms with autocorrelation properties resembling a Dirac delta function), or that allow computationally-simple processing (e.g., waveforms with sparse signal bursts in relatively long silent intervals), or that are otherwise advantageous for a particular embodiment. For example, in a RaaS LTE deployment, it may be desired to deploy a beacon transmitting waveforms that can be processed efficiently by the RRUs in the deployment. This might include waveforms having similar properties with respect to the waveforms processed by the RRUs for main-functionality LTE uplink reception, such as waveforms that may be efficiently processed with FFT operations.

A beacon may be a device that, at least temporarily, performs only a subset of the functionalities of a certain complete device, with such subset including functionalities that may aid synchronization of other devices. In a first LTE example, an eNB beacon may implement only a subset of the functionalities implemented by a complete eNB, such as transmitting standard-compliant LTE signals including, but not limited to, one or more of PSS, SSS, CRS, PBCH, PDCCH, PDSCH, or PMCH. It may also be configured to prevent any UE from camping so that functionalities such as high-throughput PDSCH transmission and PUSCH reception are not performed. In a second LTE example, a UE beacon may implement only a subset of the functionalities implemented by a complete UE, such as having a simplified receiver, able to process a limited set of broadcast signals (PSS, SSS, CRS and PBCH for example), and a simplified transmitter, able to transmit PRACH.

At least one beacon may be placed in a location selected on the basis of at least one of the criteria discussed herein. So for example, in a RaaS deployment, a beacon may be placed to maximize the number of RRUs in the deployment expected to receive the synchronization-assisting radio-frequency signal transmitted by the beacon with an SNR exceeding a certain threshold. A beacon may be moved over time, and the logic driving such moves, such as what direction to move to, when to move, when to stop, where to stop, may be based on at least one of the criteria disclosed herein. So for example, in a RaaS deployment, a beacon may be moved around the deployment so that each RRU in the deployment is guaranteed, at least for part of the time, to receive the synchronization-assisting radio-frequency signal transmitted by the beacon with an SNR exceeding a certain threshold. When at least two beacons are deployed, the logic driving the positioning or the movements of the beacons (or a subset thereof) may jointly consider the positions or the movements of different beacons. The position of at least one beacon (absolute, or relative to at least one other device) may be computed or estimated, and possibly updated over time. This may be done by any appropriate method of mechanism, including those described herein.

In a first example, a beacon may be equipped with a GPS receiver and the position of the beacon may be estimated on the basis of the GPS signals. In a second example, a RaaS LTE BBU may compare the LTE uplink signals, such as PUCCH, PUSCH, DMRS, SRS, and PRACH, received by different RRUs relatively to the same UE beacon's transmission, and estimate the position of the beacon, absolute or relative to the RRUs. In a third example, an LTE UE beacon may perform a RACH procedure towards an eNB and may use the timing advance command received in the random access response (RAR) of the RACH procedure to estimate its position relative to the eNB, or its absolute position if the eNB's position is known or can be estimated. In a fourth example, an LTE UE beacon may use the strategy presented in the third example with different eNBs, at the same time or at different times, to estimate its position, absolute or relative to the eNBs.

Some embodiments may be aided by at least one beacon that transmits synchronization-assisting radio-frequency signals on a frequency spectrum that overlaps with the spectrum on which one or more RRUs in the deployment perform main-functionality reception. For example, in a RaaS LTE deployment, one or more beacons may transmit signals that at least one RRU is able to receive also performing main-functionality LTE uplink reception. This strategy may limit, or remove completely, the occurrence of times at which the RRUs are unable to perform main-functionality reception, and consequently limit, or remove completely, the impact of the occurrences on the scheduling decisions and other RAN configurations. At least one beacon in some embodiments may transmit signals that are compliant with the uplink signals of the RAN standard of the deployment. So for example, in a RaaS LTE deployment, a UE beacon may transmit signals such as PUCCH, PUSCH, DMRS, SRS, and PRACH. In such embodiments, the logic controlling the synchronization of the deployment may be aware of the presence of the beacon, and the awareness may influence scheduling decisions and other RAN configurations. So in an example RaaS LTE deployment aided by a UE beacon, the UE beacon may be scheduled for uplink PUSCH traffic only on PUSCH resources on which no other UE is scheduled, or may be scheduled for contention-free PRACH specifically to aid RRU synchronization in the deployment, or may be configured for contention-based PRACH with parameters, such as the pre-amble group, that may limit, or remove, the occurrences of interference with other UEs' PRACH. Alternatively, or in addition, at least one beacon may transmit signals that are not compliant with the uplink signals of the RAN standard of the deployment. For example, in a RaaS LTE deployment, a beacon may transmit synchronization signals in portions of the spectrum received by the RRUs in the deployment on which no LTE uplink signal is transmitted (the uplink guard bands).

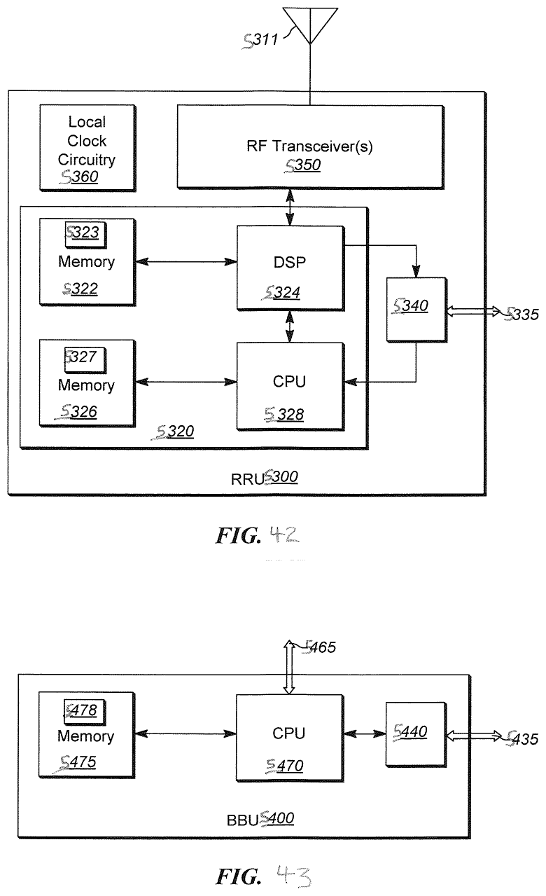

FIG. 42 is a block diagram of an embodiment of an RRU 5300. The RRU 5300 is an electronic device that includes a processing subsystem 5320 which includes at least one processor 5324, 5328 and at least one non-transitory computer memory 5322, 5326 coupled to the at least one processor 5324, 5328. The at least one non-transitory computer memory 5322, 5326 holds instructions 5323, 5327 executable by the at least one processor 5324, 5328, to perform functions of the RRU 5300. The RRU 5300 also includes local clock circuitry 5360 and radio-frequency transceivers 5350 to communicate with a wireless terminal using antenna 5311. The radio frequency transceivers 5350 may include one or more transmitters and one or more receivers which are independently controllable. A fronthaul link interface 5340 couples the at least one processor 5324, 5328 to the fronthaul link 5335. Thus the RRU 5300 includes an interface 5340 to the fronthaul link 5335, a processor 5324, 5328, coupled to the fronthaul link 5335, and at least one non-transitory machine readable medium 5322, 5326, coupled to the processor 5324, 5328, and storing one or more instructions 5323, 5327 that in response to being executed by the processor 5324, 5328 cause the RRU 5300 to carry out at least one of the functions of an RRU described herein.

In some embodiments, the processing subsystem 5320 may include a general purpose CPU 5328 and a digital signal processor (DSP) 5324 with various tasks split between the processors 5324, 5328 as having the DSP 5324 perform the FFT and IFFT operations and having the CPU 5328 provide control functionality. In other embodiments, the processing subsystem 5320 may only include the DSP 5324 and may not include the CPU 5328. In such embodiments, the DSP 5324 may be able to provide control functionality, or the control functionality may be provided by other circuitry. In other embodiments, the processing subsystem 5320 may only include the CPU 5328 and not include the DSP 5324. In such embodiments, the CPU 5328 may be able to perform signal processing functions such as one or more of a FFT, IFFT, selection, quantization, adaptive compression, expansion, formatting, and the like or the raw samples may be sent to a BBU for the signal processing functionality. Alternatively, dedicated circuitry may be provided for some of the signal processing functions so the CPU 5328 can provide the overall control functionality. Other embodiments may have any number of processors of any type, with various functions distributed to the various processors in any way, depending on the embodiment.

In embodiments, instructions 5322, 5327 to cause the processor 5324, 5328 to perform a method for synchronizing a remote radio unit (RRU) in a distributed radio access network (RAN) are stored in the memory 5322, 5326. The method performed by the processor 5324, 5328 includes receiving a synchronization-assisting radio-frequency signal and sending information derived from the synchronization-assisting radio-frequency signal over a fronthaul link 5335 to a baseband unit (BBU).

The method also includes controlling a local clock 5360 in the RRU 5300 using the fronthaul link 5335. In some embodiments, the fronthaul link 5335 is a synchronous fronthaul link and the local clock 5360 in the RRU 5300 is locked to the fronthaul link 5335. In at least one embodiment, the synchronous fronthaul link uses a common public radio interface (CPRI) protocol and CPRI synchronization is used to control the local clock 5360 in the RRU 5300. In some embodiments, the RRU 5300 uses the fronthaul link 5335 to receive synchronization instructions from the BBU, the synchronization instructions determined based on the information derived from the synchronization-assisting radio-frequency signal and sent to the BBU. The synchronization instructions can then be used to control the local clock 5360 in the RRU 5300. The synchronization instructions may include an instruction to change a frequency, a phase, or other aspects of the local clock 5360. In some embodiments, the fronthaul link 5335 is a non-deterministic fronthaul link and the local clock 5360 in the RRU 5300 is adjusted based on the synchronization instructions received. In some embodiments, the non-deterministic fronthaul link utilizes an internet protocol (IP).

In embodiments, the RRU 5300 communicates with at least one wireless terminal using radio-frequency signals, performs at least a first portion of a first-level protocol of the RAN, and communicates data of the communication with the at least one wireless terminal over the fronthaul link 5335 with the BBU. In some embodiments, the RAN protocol utilizes an Evolved Universal Terrestrial Radio Access Network (E-UTRAN), and the first-level protocol is an Evolved Universal Terrestrial Radio Access (E-UTRA) physical-layer (PHY) protocol.

In an embodiment, the radio-frequency transceivers 5350 include two separate radio-frequency receivers, and the RRU tunes a first radio-frequency receiver to an uplink frequency, receives uplink data through the first radio-frequency receiver, and sends the uplink data to the BBU over the fronthaul link 5335. The RRU also tunes a second radio-frequency receiver to a carrier frequency of the synchronization-assisting radio-frequency signal, receives the synchronization-assisting radio-frequency signal through the second radio-frequency receiver, and sends information derived from the synchronization-assisting radio-frequency signal to the BBU over the fronthaul link 5335.

In another embodiment, the radio frequency transceivers 5350 include a single radio-frequency receiver, and the RRU 5300 tunes the radio-frequency receiver in the RRU to an uplink frequency for a first period of time, receives uplink data through the first radio-frequency receiver during the first period of time, and sends the uplink data to the BBU over the fronthaul link 5335. The RRU 5300 then tunes the radio-frequency receiver to a carrier frequency of the synchronization-assisting radio-frequency signal during a second period of time that is non-over-lapping with the first period of time, receives the synchronization-assisting radio-frequency signal through the radio-frequency receiver during the second period of time, and sends information derived from the synchronization-assisting radio-frequency signal to the BBU over the fronthaul link 5335.

In yet another embodiment, the radio frequency transceivers 5350 include a single wideband radio-frequency receiver. The RRU 5300 may use the wideband radio-frequency receiver to simultaneously receive both uplink data in a first frequency sub-band and the synchronization-assisting radio-frequency signal in a second frequency sub-band. The uplink data and the information derived from the synchronization-assisting radio-frequency signal are then sent to the BBU over the fronthaul link.

In embodiments, the RRU 5300 receives control instructions from the BBU over the fronthaul link 5335 and controls at least one aspect of the receiving of the synchronization-assisting radio-frequency signal or the derivation of the information from the synchronization-assisting radio-frequency signal based on the control instructions. Control instructions can include, but are not limited to, an instruction to set a receive frequency for a radio-frequency receiver in the RRU 5300 or an instruction to set a time period of the synchronization-assisting radio-frequency signal to use to create the information derived from the synchronization-assisting radio-frequency signal.

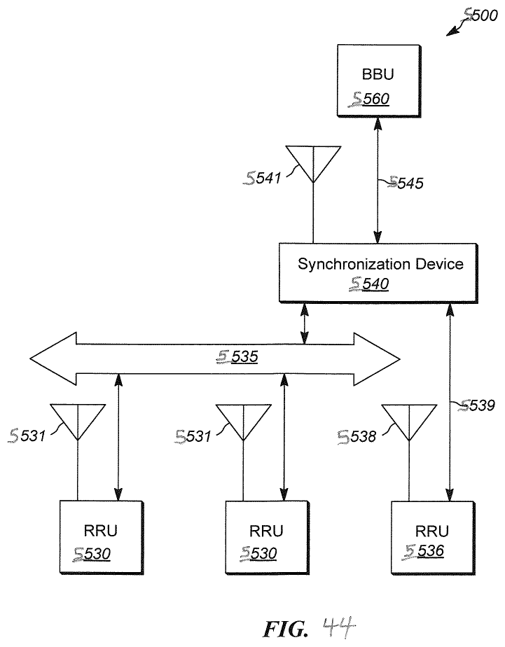

FIG. 43 is a block diagram of an embodiment of a baseband unit (BBU) 5400 for use with a remote radio unit (RRU) in a distributed radio access network (RAN) that is coupled to a core network. The BBU 5400 is an electronic device that includes a processor 5470, one or more memory devices 5475 coupled to the processor 5470 and storing instructions 5478 to configure the processor 5470, and interface circuitry 5440 coupled to the processor 5470 and a fronthaul link 5435. The BBU 5400 also includes an interface 5465 for communicating with a core network of the RAN. In some embodiments, the BBU 5400 may use a common interface to a network to use for both the fronthaul link 5435 and backhaul link. The instructions 5478 may cause the processor 5470 to perform any function of a method for a BBU described herein. The processor 5470 is configured to perform at least a second-level protocol of the RAN and communicate over the fronthaul link 5435, communicating data with the RRU for communication with a wireless terminal. The fronthaul link 5435 may be a synchronous fronthaul link, and may, for example, use a CPRI protocol. In other embodiments, the fronthaul link may be a non-deterministic fronthaul link, and may, for example, use an internet protocol (IP). In some embodiments, the BBU 5400 supports a RAN protocol utilizing an Evolved Universal Terrestrial Radio Access Network (E-UTRAN), the core network includes an Evolved Packet Core (EPC), the first-level protocol uses an Evolved Universal Terrestrial Radio Access (E-UTRA) physical-layer (PHY) protocol, and the second-level protocol uses an E-UTRA medium access control (MAC) protocol.

The processor 5470 may perform a variety of functions to manage and control the RRU. In embodiments the processor 5470 is configured to synchronize a remote radio unit (RRU) in a distributed radio access network (RAN) by receiving information derived from a synchronization-assisting radio-frequency signal over a fronthaul link 5435 from the RRU, processing the information derived from a synchronization-assisting radio-frequency signal to determine synchronization instructions, and using the synchronization instructions and the fronthaul link 5435 to control a local clock in the RRU. In a RAN where the BBU 5400 is associated with more than one RRU, the BBU 5400 may receive and process information from multiple RRUs derived from the synchronization-assisting radio-frequency signal and use the information received from the multiple RRUs to determine the synchronization instructions.

The synchronization instructions can include, but are not limited to, an instruction to change a frequency or a phase of the local clock. In some embodiments, the synchronization instructions are determined based, at least in part, on a determined physical location of the RRU. In some embodiments, the fronthaul link 5435 is a synchronous fronthaul link and the BBU 5400 generates a clock for the fronthaul link 5435 based on the synchronization instructions. In some embodiments, the synchronization instructions are sent to the RRU over the fronthaul link.

In some embodiments, the device transmitting the synchronization-assisting radio-frequency signal is in communication with the BBU 5400, and the BBU 5400 sends control instructions to the device controlling at least one aspect of the synchronization-assisting radio-frequency signal transmitted by the device. The at least one aspect can include, but is not limited to, a time period of transmission, a transmission power, or a carrier frequency of the synchronization-assisting radio-frequency signal transmitted by the device.

So in some embodiments, the BBU can send control instructions to the RRU to change a frequency to use for reception of the synchronization-assisting radio-frequency signal. The BBU may determine the frequency based on a quality metric of received information derived from the synchronization-assisting radio-frequency signal. The quality metric of the received information may be, but is not limited to, a signal-to-noise ratio. The BBU may alternatively or additionally send control instructions to the RRU to change a time period of the synchronization-assisting radio-frequency signal to use to create the information derived from the synchronization-assisting radio-frequency signal. The time period may be based on a schedule of communication between the RRU and a wireless terminal or a schedule of communication between another RRU and a wireless terminal. In embodiments the BBU may send control instructions to the RRU to schedule communication between the RRU and a wireless terminal selected to avoid a time period of the synchronization-assisting radio-frequency signal to use to create the information derived from the synchronization-assisting radio-frequency signal.

FIG. 44 is a block diagram of an embodiment of a distributed RAN 5500 using a synchronization device 5540. In some embodiments of a RAN, an intermediate network unit, or synchronization device 5540, may be placed between the BBU 5560 and one or more RRUs 5530, 5536. The synchronization device 5540 may communicate with the BBU via the RaaS-FIP protocol, possibly over a packet-switched fronthaul link 5545, or any other type of connection. The synchronization device 5540 may be able to achieve accurate synchronization via at least one of the techniques described herein by receiving a synchronization-assisting radio-frequency signal through antenna 5541. Depending on the embodiment, the synchronization device 5540 can utilize one or more fronthaul links 5535, 5539 to communicate with various RRUs 5530, 5536, with some embodiments using a fiber-grade low-latency low-jitter fronthaul link 5539 such as CRPI to communicate with the RRU 5536 and some embodiments using a non-deterministic fronthaul link 5535, such as RaaS-FIP, to communicate with other RRUs 530. Any combination of various fronthaul links may be used to communicate with RRUs 5530-5536 depending on the embodiment.

The synchronization device 5540 may be specifically tailored to acquire synchronization and ‘distribute’ it to at least one RRU 5530, 5536, and/or the synchronization may be used for other purposes as well. In one embodiment, the synchronization device 5540 may be a network router, part of wired or wireless network deployment to support mobile base stations. In an embodiment, the synchronization device 5540 may also be an RRU which includes all of the radio functionality of an RRU, besides providing synchronization to the at least one other RRU.

In another embodiment, the synchronization device 5540 may be a macrocell, placed outdoors, possibly with antennas deployed on a tower, and the at least one RRU 5530, 5536 may be deployed in its vicinity. In such an embodiment, the synchronization device 5540 keeps both the macrocell (which may possibly include multiple sectors) and the at least one RRU 5530, 5536 synchronized.

In yet another embodiment, the synchronization device 5540 may be a fronthaul protocol converter and be used to convert RaaS-FIP into CPRI. In the implementation, the RRU 5536 may be a CPRI-compatible remote radio head (RRH).

The synchronization device 5540 may be deployed on a roof, or anyway in an outdoor location with good reception of a synchronization-assisting radio-frequency signal, such as a GPS signal, or the like, whereas the at least one connected RRU 5530, 5536 may be deployed in-doors, where the reception of the synchronization-assisting radio-frequency signal may be im-possible or with a limited quality and reliability.

The synchronization device 5540 may, in some embodiments, be connected to an RRU 5536 via a circuit-switched fronthaul connection 5539 able to accurately convey synchronization information to the RRU 5536, such as by using CPRI over a fiber-grade low-latency low-jitter link 5539 using the mechanisms provided by CPRI for conveying synchronization information. As an alternative to using CPRI for data communication, the synchronization device 5540 may still use RaaS-FIP to communicate with the at least one RRU 5536, but on a low-latency low-jitter circuit-switched link 5539. In such an embodiment, separate clock-related information may be conveyed over the link, in addition to the RaaS-FIP signal, to keep the at least one RRU 5536 synchronized. Additionally or alternatively, the synchronization device 5540 may distribute synchronization information to the at least one RRU 5530 over a non-deterministic fronthaul link 5535.

In embodiments, the RRUs 5530, 5536 connected to the synchronization device 5540 are synchronized using a common clock source, generated from the synchronization device 5540 according to at least one synchronization method described herein. The RRUs 5530-5536 may be co-located, deployed in the same box, tower, building, corporate campus, geographical location, or the like. The synchronized nature of the co-located RRUs may be leveraged to improve the performance of the deployment via techniques such as CoMP, whose benefit is greater when ap-plied to co-located, densely-deployed RRUs.

An embodiment of the synchronization device 5540 includes a first interface to a first fronthaul link 5545 coupled to the BBU 5560, and a second interface to the second fronthaul link 5535, 5539 coupled to an RRU 5530, 5536. The synchronization device 5540 also includes a processor, coupled to the first interface and the second interface which is coupled to at least one non-transitory machine readable medium which includes one or more instructions that in response to being executed by the processor cause the synchronization device to carry out at least one of the methods disclosed herein.

In some embodiments, the synchronization device 5540 receives uplink data from an RRU 5530 over the second fronthaul link 5535 and sends the uplink data to the BBU 5560 over the first fronthaul link 5545, which may be a non-deterministic link. A radio-frequency receiver in the synchronization device 5540 is tuned to a carrier frequency of the synchronization-assisting radio-frequency signal (SARFS) and the SARFS is received through the radio-frequency receiver. Examples of the SARFS include, but are not limited to, a GPS satellite signal, a downlink signal from a cellular base station, a television broadcast signal, an uplink signal from a cellular terminal, or a time broadcast signal. Information derived from the SARFS is then sent over the second fronthaul link 5545 to the BBU 5560. The information derived from the SARFS may simply be digitized samples of the SARFS, digitized samples of an intermediate frequency (IF) signal generated from the SARFS, digitized samples of a baseband signal carried by the SARFS, data generated by using signal processing techniques, such as an inverse fast-Fourier transform (IFFT), performed on the SARFS, the IF signal, or the baseband signal, a compressed version of one of the data types previously mentioned, or any other type of data derived from the SARFS.

The BBU 5560, or some other upstream device that receives the information derived from the SARFS, processes that information to generate synchronization instructions to synchronize the local clock of the synchronization device 5540 to the RAN 5500 and sends those instructions to the synchronization device 5540. The synchronization device 5540 receives the synchronization instructions, determined based on the information derived from the SARFS, from the BBU 5560 over the fronthaul link 5545 and uses those instructions to control its local clock. The synchronization device 5540 then controls a local clock in the RRU 5530, 5536 using the fronthaul link 5535, 5539, thus using the synchronization instructions to control the local clock in the RRU 5530, 5536. In some embodiments, at least one of the fronthaul links is a synchronous fronthaul link 5539, and the local clock in the RRU 5536 is locked to the fronthaul link 5539 to control the local clock of the RRU 5536. The fronthaul link 5539 in at least one embodiment uses a common public radio interface (CPRI) protocol and CPRI synchronization is used to control the local clock in the RRU 5536. In some embodiments, synchronization instructions may be sent to one or more RRUs 5530, 5536 over a fronthaul link 5535, 5539. Synchronization instructions may include an instruction to change a frequency or a phase of the local clock.

The number of ports for the base band unit and/or the number of ports for the remote radio units tends to incur additional complexity into each of the devices. Also, with an ever increasing density of remote radio units for an area, the number of connections to support the Ethernet-like based interconnections becomes burdensome and tends to require substantial space to route a bundle of Ethernet-like cables. To support such an increased density of remote radio units together with supporting less space for routing cables, it is desirable to employ a passive optical network based technology.

A passive optical network (PON) is often employed as an access network, or a portion of a larger communication network. The communication network typically has a high-capacity core portion where data or other information associated with telephone calls, digital television, and Internet communications is carried substantial distances. The core portion may have the capability to interact with other networks to complete the transmission of telephone calls, digital television, and Internet communications. In this manner, the core portion in combination with the passive optical network enables communications to and communications from subscribers (or otherwise devices associated with a subscriber, customer, business, or otherwise).

The access network of the communication network extends from the core portion of the network to individual subscribers, such as those associated with a particular residence location (e.g., business location). The access network may be wireless access, such as a cellular network, or a fixed access, such as a passive optical network or a cable network.

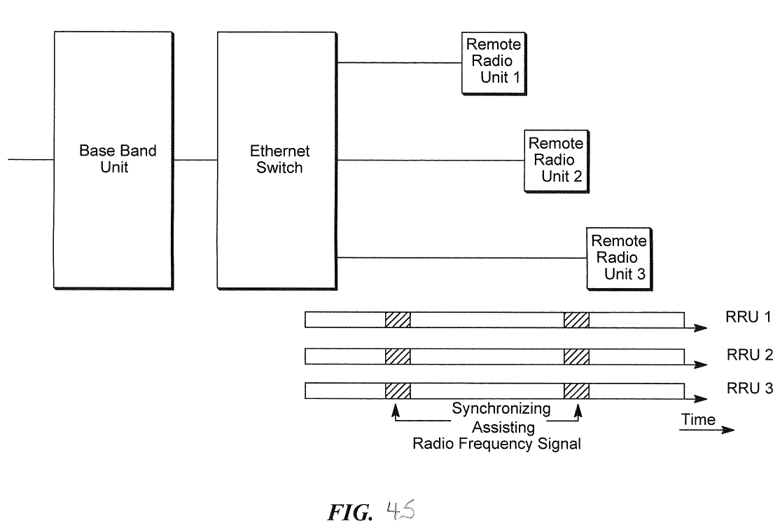

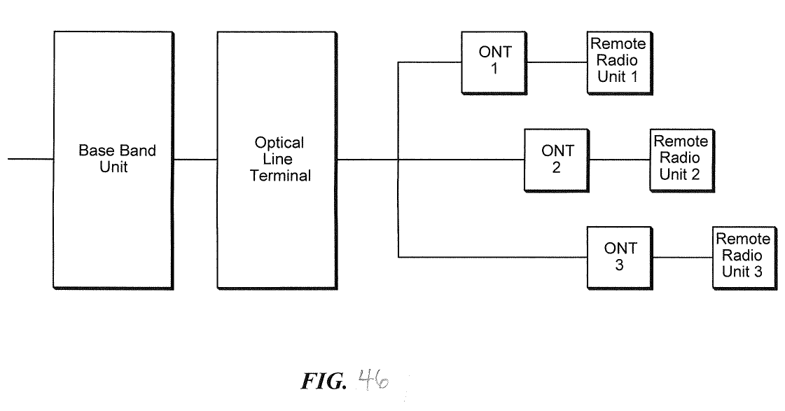

Referring to FIG. 45, a simplified architecture for the remote radio units is illustrated between an Ethernet switch and the set of remote radio units. The baseband unit includes the associated Ethernet switch which accordingly directs signals to each of the remote radio units (e.g., remote radio unit 1, remote radio unit 2, remote radio unit 3). The distance to each of the remote radio units may be a different distance, and accordingly the propagation delay to each of the radio units is different. A simplified timing diagram for the signals from the Ethernet switch to the corresponding remote radio units is illustrated showing that signals include a synchronization assisting radio frequency signal (e.g., any suitable data that may be used for synchronization) so that the data among the different remote radio units may be temporally aligned with one another.

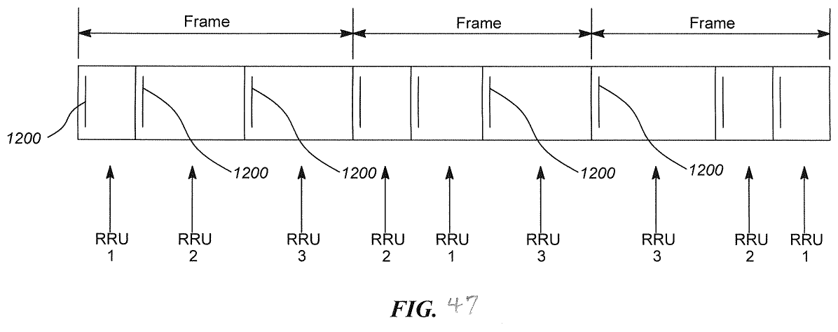

Referring to FIG. 46, a simplified architecture for the remote radio units is illustrated that includes an optical line terminal as part of the network. The Ethernet switch is removed from the network (i.e., an Ethernet switch positioned between the baseband unit and the remote radio units) and an optical line terminal is included as part of the architecture. The baseband unit provides signaling to the north side interface of the optical line terminal, preferably in the same manner as it would have done if it was providing signaling to an Ethernet switch. The south side interface(s) of the optical line terminal is interconnected to a respective optical network terminal for a corresponding remote radio unit (e.g., ONT 1/remote radio unit 1; ONT 2/remote radio unit 2; ONT 3/remote radio unit 3). The optical line terminal is interconnected to the respective ONTs through a respective optical fiber(s), which may include splitters and other optical components. The ONTs receive the signaling from the OLT, based upon a passive optical network based signaling technique. Each of the ONTs receive the transmitted signaling and in response provide the signaling, typically using an Ethernet based communication (as previously described) to a respective remote radio unit. The corresponding pairs of remote radio units and the ONTs may be separate devices or otherwise integrated together as a single device. Each of the pairs of remote radio units/ONTs transmits data on its corresponding optical fiber to the optical line terminal based upon its bandwidth allocation provided by the optical line terminal. The optical line terminal in turn transmits the received data to the baseband unit.

Referring to FIG. 47, the optical line terminal sends data to the ONTs with a series of frames and sets of data for one or more ONTs included within the set of frames. The synchronization assisting radio frequency signal for each of the RRUs would be included as part of the data within the data for a respective ONT. However, as a result of differences in the signaling manner of Ethernet based technologies with respect to passive optical network-based technologies, the data arrives at different times and may be rearranged in a different manner depending on how the data is arranged within each of the frames. Since the baseband unit does not necessarily control the manner in which the optical line terminal transmits data to respective ONTs (and RRUs) it is desirable to include PON synchronization data 51200 within each of the sets of data for a respective ONT. The PON synchronization data 51200 within a respective frame preferably indicates an offset of its corresponding data for an ONT relative to the corresponding data for the other ONTs. Thus, the PON synchronization data 51200 for each ONT is likely different in most cases. In this manner, for a frame, each of the PON synchronization data 51200 may indicate a reference offset to the end of the frame or some other offset position. In this manner, the ONTs and/or the RRUs may realign the offsets as a result of transmitting the data using the PON access network, to an alignment as expected by the respective RRUs for broadcasting data in a manner that would have otherwise occurred if the Ethernet based switch were included without the PON access network.

It is noted that the baseband unit may include a distributed unit (which typically includes the RLC, MAC and part of the PHY layer) and/or a central unit (which typically includes non-real time, and higher L2 and L3 networking functionality). The baseband unit typically includes mid-haul and/or front-haul interconnections to the

For example, the RRUs may be provided signaling information based upon the PON synchronization data where each of the RRUs broadcasts data in a simultaneous manner. For example, the RRUs may be provided signaling information based upon the PON synchronization data where each of the RRUs broadcasts data in a temporally offset manner, preferably in a non-overlapping manner.

Moreover, each functional block or various features in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. An optical network terminal for a passive optical network comprising:
(a) said optical network terminal includes a north bound interface that is capable of receiving and sending data;
(b) said optical network terminal includes a port that is capable of receiving and sending optical data from and to an optical line terminal, respectively, through an optical fiber;
(c) said optical network terminal pre-allocating a plurality of portions of a first frame for transmitting time sensitive messages, where said pre-allocating is not based in response to receiving data nor a request for transmitting data;
(d) said optical network terminal identifying a time sensitive message that is received by said optical network terminal while transmitting said first frame of said optical data;
(e) said optical network terminal transmitting said time sensitive message as part of said first frame.

2. The optical network terminal of claim 1 wherein said optical network terminal transmits said first frame to a baseband unit across a fronthaul interconnection.

3. The optical network terminal of claim 1 wherein said optical network terminal transmits said first frame to a distributed unit across a fronthaul interconnection.

4. The optical network terminal of claim 1 wherein said optical network terminal transmits said first frame across a fronthaul interconnection.

5. The optical network terminal of claim 1 wherein said time sensitive message is a RACH message.

6. The optical network terminal of claim 1 wherein said time sensitive message is a HARQ message.

7. The optical network terminal of claim 1 wherein said optical network terminal is prohibited from using said pre-allocated plurality of portions of said first frame for general video and/or audio data.

8. An optical network terminal for a passive optical network comprising:
(a) said optical network terminal includes a north bound interface that is capable of receiving and sending data;
(b) said optical network terminal includes a port that is capable of receiving and sending optical data from and to an optical line terminal, respectively, through an optical fiber;
(c) said optical network terminal pre-allocating a plurality of portions of a first frame for transmitting messages prior to an allocation for said frame by a dynamic bandwidth allocation technique;
(d) said optical network terminal identifying a message that is received by said optical network terminal while transmitting said first frame of said optical data;
(e) said optical network terminal transmitting said message as part of said first frame.

9. An optical network terminal for a passive optical network comprising:
(a) said optical network terminal includes a north bound interface that is capable of receiving and sending data;
(b) said optical network terminal includes a port that is capable of receiving and sending optical data from and to an optical line terminal, respectively, through an optical fiber;
(c) said optical network terminal pre-allocating a plurality of portions of a plurality of frames for transmitting time sensitive messages;
(d) said optical network terminal identifying time sensitive messages that are received by said optical network terminal while transmitting said plurality of frames of said optical data, where said time sensitive messages are selected from a logical data channel and from a logical control channel;
(e) said optical network terminal transmitting said time sensitive messages as part of said plurality of frames.

10. An access network for a passive optical network comprising:
(a) an optical line terminal includes a north bound interface that is capable of receiving and sending data, respectively;
(b) said optical line terminal includes a port that is capable of receiving and sending optical data from and to a set of one or more optical network terminals, respectively, through an optical fiber;
(c) said optical line terminal pre-allocating a plurality of portions of a first frame for transmitting time sensitive messages, where said pre-allocating is not based in response to receiving data nor a request for transmitting data;
(d) said optical line terminal identifying a time sensitive message that is received by said optical line terminal while transmitting said first frame of said optical data;
(e) said optical line terminal transmitting said time sensitive message as part of said first frame.

11. The access network of claim 10 wherein said optical line terminal is a remote optical line terminal.

12. The access network of claim 10 wherein said optical line terminal transmits said first frame to a baseband unit across a fronthaul interconnection.

13. The access network of claim 10 wherein said optical line terminal transmits said first frame to a distributed unit across a fronthaul interconnection.

14. The access network of claim 10 wherein said optical line terminal transmits said first frame across a fronthaul interconnection.

15. The access network of claim 10 wherein said time sensitive message is a RACH message.

16. The access network of claim 10 wherein said time sensitive message is a HARQ message.

17. The access network of claim 10 wherein said optical line terminal is prohibited from using said pre-allocated plurality of portions of said first frame for general video and/or audio data.

18-89. (canceled)
